(19) United States
(12) Patent Application Publication
(10) Pub. No.: US 2013/0099747 A1
(43) Pub. Date: Apr. 25, 2013

(54) CHARGE/DISCHARGE SYSTEM FOR BATTERY PACK

(71) Applicants: NIPPON SOKEN, INC., Nishio-city (JP); DENSO CORPORATION, Kariya-city (JP)

(72) Inventors: Hiroyasu BABA, Chiryu-shi (JP); Koji KAWASAKI, Anjo-shi (JP); Yasuyuki HASEO, Nishio-shi (JP); Koji YAMAZAKI, Kariya-shi (JP)

(73) Assignees: DENSO CORPORATION, Kariya-city (JP); NIPPON SOKEN, INC., Nishio-city (JP)

(21) Appl. No.: 13/650,312

(22) Filed: Oct. 12, 2012

(30) Foreign Application Priority Data
Oct. 13, 2011 (JP) 2011-225636
Mar. 6, 2012 (JP) 2012-048905

(51) Int. Cl. H02J 7/00

(52) U.S. Cl. CPC H02J 7/0014
USPC 320/118

(57) ABSTRACT

A charge/discharge system is provided to shuttle electric energy in a battery pack made up of battery cells connected in series. The charge/discharge system includes an electric energy storage, a switch, and a charge/discharge controller. The charge/discharge controller selectively places the switch in a charging mode to charge electric energy from one or a selected number of ones of the battery cells to one or a selected number of other ones of the battery cells to minimize a variation in state of charge among the battery cells.

### CROSS REFERENCE TO RELATED DOCUMENT

The present application claims the benefit of priority of Japanese Patent Application Nos. 2011-225636 filed on Oct. 13, 2011 and 2012-48905 filed on Mar. 6, 2012, the disclosures of which are incorporated herein by reference.

### BACKGROUND

1. Technical Field

This disclosure relates generally to a charge/discharge system for a battery pack made up of a plurality of battery cells connected in series.

2. Background Art

Japanese Patent First Publication No. 2004-88878 discloses a charge/discharge system for a battery pack (also called an assembled battery) which is designed to use a transformer mainly to charge one of some of battery cells which are low in terminal voltage thereof. Specifically, the transformer is equipped with a primary winding and a plurality of secondary windings which are electrically connected to the battery cells in parallel, respectively. The terminal voltage at the battery pack is applied to the primary winding which is electromagnetically connected to the secondary windings, thereby focusing the charging of electromagnetic energy, which is to be stored in the battery pack, on one or some of the battery cells which are low in terminal voltage thereof.

The above charge/discharge system is, however, engineered to release the electric energy from all the battery cells once, in other words, undesirably discharge one or some of the battery cells for a while, which should be charged. This results in an increase in time consumed to completely charge the battery cells which are lower in terminal voltage or a loss in electric power arising from the temporary release of energy from that battery cells.

### SUMMARY

It is therefore desirable to provide a charge/discharge device for a battery pack which is designed to transfer or shuttle electric energy between battery cells of the battery pack.

According to one aspect of an embodiment, there is provided a charge/discharge system which may be employed in supplying power to an electric motor to drive an automotive vehicle. The charge/discharge system comprises: (a) an electric energy storage; (b) a battery pack in which a plurality of battery cells are disposed in series connection with each other; (c) a switch which works to selectively establish an electrical connection of a first cell group made up of one or a first number of adjacent ones of the battery cells with the electric energy storage in a first switching operation mode and an electrical connection of a second cell group made up of one or a second number of adjacent ones of the battery cells with the electric energy storage in a second switching operation mode; and (d) a charge/discharge controller which selectively places the switch in the first switching operation mode to establish a charging mode to charge electric energy from the first cell group to the electric energy storage and the second switching operation mode to establish a discharge mode to discharge electric energy from the electric energy storage to the second cell group.

Specifically, the charge/discharge system works to transfer the electric energy from the first cell group to the second cell group in the battery pack, thereby minimizing a variation in, for example, state of charge among the battery cells.

The first number may be greater than the second number. This results in an increased difference between a terminal voltage developed across the second cell group and a voltage charged in the electric energy storage when the second cell group is connected to the electric energy storage, thereby increasing the amount of electric energy transferred from the first cell group to the second cell group.

The charge/discharge controller may control an operation of the switch to change a difference between the first number and the second number. In other words, the charge/discharge controller changes a difference between the terminal voltage developed across the second cell group and the voltage at the electric energy storage when the second cell group is connected to the electric energy storage. This permits the rate at which the electric energy is transmitted form the first cell group to the second cell group to be increased and also permits a variation in difference between the terminal voltage developed across the second cell group and the voltage at the electric energy storage when the second cell group is connected to the electric energy storage to be minimized.

The charge/discharge controller may transfer the electric energy from the first cell group to the electric energy storage in the first switching operation mode and then release the electric energy from the electric energy storage to the second cell group in the second switching operation mode to regulate a state of charge in each of the battery cells. This ensures the stability of state of charge in the battery pack.

The switch may be designed to include a plurality of pairs of circuit paths each pair of which establishes an electric connection of terminals of one of the battery cells with terminals of the electric energy storage. The switch works to open or close each of the pairs circuit paths and permit an electric current to flow bi-directionally in each of pairs of the circuit paths. This results in an increased range of options to choose the first and second cell groups.

The charge/discharge controller may select a higher charged battery cell that is one of the battery cells which is greater in one of terminal voltage, state of charge, and charged capacity and a lower charged battery cell that is one of the battery cells which is smaller in one of terminal voltage, state of charge, and charged capacity. The first cell group includes the higher charged battery cell or a combination of the higher charged battery cell and at least one of the battery cells connected adjacent the higher charged battery cell. The second cell group includes the lower charged battery cell or a combination of the lower charged battery cell and at least one of the battery cells connected adjacent the lower charged battery cell. This minimizes a variation in one of terminal voltage, state of charge, and charged capacity in the battery pack.

The switch may be configured to change a difference between the first number of the battery cells to be connected to the electric energy storage in the charging mode and the second number of the battery cells to be connected to electric energy storage in the discharging mode. The charge/discharge controller controls an operation of the switch to change the difference between the first number and the second number. This enables a variation in difference between the terminal voltage developed across the second cell group and the voltage at the electric energy storage when the second cell group is connected to the electric energy storage to be minimized.

The charge/discharge controller may be designed to measure a voltage, as developed across terminals of each of the battery cells to control the operation of the switch.

The charge/discharge may alternatively serve to measure a voltage, as developed across terminals of the electric energy storage to an operation of the switch.

The charge/discharge system may also include a low-pass filter disposed between the electric energy storages and the charge/discharge controllers.

One of the circuit paths of each of the pairs may work as a first circuit path which connects between a joint between adjacent two of the battery cells and one of the terminals of the electric energy storage, while the other of the circuit paths may work as a second circuit path which selectively establishes an electric connection between the joint and the other of the terminals of the electric energy storage.

When a first battery cell that is one of the battery cells has failed in operation, the charge/discharge controller may work as a fail-safe device to close the second circuit path joined to the first battery cell to establish the electric connection between the joint of the other of the terminals of the electric energy storage. This ensures the stability in providing the electric power to an external device.

According to another embodiment, there is provided a charge/discharge system which comprises: (a) a battery pack made up of a plurality of modules connected electrically to each other, each of the modules including a plurality of battery cells connected in series with each other; (b) a common electric energy storage; (c) in-module electric energy storages each of which is disposed in one of the modules; (d) a common switch which works to selectively establish an electrical connection of a first module group made up of one or a first number of adjacent ones of the modules with the common electric energy storage in a first switching operation mode and an electrical connection of a second module group made up of one or a second number of adjacent ones of the modules with the common electric energy storage in a second switching operation mode; (e) in-module switches each of which is disposed in one of the modules, each of the in-module switches working to selectively establish an electrical connection of a first cell group made up of one or a first number of adjacent ones of the battery cells in a corresponding one of the modules with a corresponding one of the in-module electric energy storages in a third switching operation mode and an electrical connection of a second cell group made up of one or a second number of adjacent ones of the battery cells in a corresponding one of the modules with a corresponding one of the in-module electric energy storage in a fourth switching operation mode; (f) a common charge/discharge controller which selectively places the common switch in the first switching operation mode to establish a charging mode to charge electric energy from the first module group to the common electric energy storage and the second switching operation mode to establish a discharge mode to discharge electric energy from the common electric energy storage to the second module group; and (g) in-module charge/discharge controllers each of which is disposed in one of the modules, each of the in-module charge/discharge controllers selectively placing a corresponding one of the in-module switches in the third switching operation mode to establish an in-module charging mode to charge electric energy from the first cell group to a corresponding one of the in-module electric energy storages and the fourth switching operation mode to establish an in-module discharge mode to discharge electric energy from the one of the electric energy storages to the second cell group.

Specifically, the charge/discharge system works to transfer the electric energy from the first cell group to the second cell group in the battery pack, thereby minimizing a variation in, for example, state of charge among the battery cells. The charge/discharge system also works to transfer the electric energy from the first module group to the second module group in the battery pack, thereby minimizing a variation in, for example, state of charge among the modules.

The common charge/discharge controller may select a higher charged module that is one of the modules which is greater in one of terminal voltage, state of charge, and charged capacity and a lower charged module that is one of the modules which is smaller in one of terminal voltage, state of charge, and charged capacity. The first module group includes the higher charged module or a combination of the higher charged module and at least one of the modules connected adjacent the higher charged module. The second module group includes the lower charged module or a combination of the lower charged module and at least one of the modules connected adjacent the lower charged module. Each of the in-module charge/discharge controllers selects a higher charged battery cell that is one of the battery cells which is greater in one of terminal voltage, state of charge, and charged capacity in a corresponding one of the modules and a lower charged battery cell that is one of the battery cells which is smaller in one of terminal voltage, state of charge, and charged capacity in the one of the modules. The first cell group includes the higher charged battery cell or a combination of the higher charged battery cell and at least one of the battery cells connected adjacent the higher charged battery cell. The second cell group includes the lower charged battery cell or a combination of the lower charged battery cell and at least one of the battery cells connected adjacent the lower charged battery cell. This minimizes a variation in one of terminal voltage, state of charge, and charged capacity in the battery pack.

The charge/discharge system may also include a plurality of pairs of circuit paths each pair of which establishes an electric connection of terminals of one of the modules with terminals of the common electric energy storage. Each of the in-module switches works to open or close each of the pairs circuit paths in a corresponding one of the modules and permit an electric current to flow bi-directionally in each of pairs of the circuit paths. This results in an increased range of options to choose the first and second module groups.

The common switch is configured to change a difference between the first number of the modules to be connected to the common electric energy storage in the charging mode and the second number of the modules to be connected to common electric energy storage in the discharging mode. The common charge/discharge controller controls an operation of the common switch to change the difference between the first number and the second number. This enables a variation in difference between the terminal voltage developed across the second module group and the voltage at the common electric energy storage when the second module group is connected to the common electric energy storage to be minimized.

A combination of the battery cells of each of the modules and at least one of the battery cells of an immediately closest neighbor one of the modules may constitute a sub-battery assembly. Each of the sub-battery assemblies is connectable with one of the in-module electric energy storages. In other words, each of the sub-battery assemblies shares a portion of another of the sub-battery assemblies, thereby permitting the electric energy to be transmitted among the battery cells of each of the modules and one or some of the battery cells of an immediately closest neighbor one or two of the modules through the in-module electric energy storages, thus permitting the electric energy to be transmitted among all the battery cells to minimize a variation in terminal voltage, state of charge, or charged capacity among the battery cells.

The battery cells of the battery pack may be broken down into a first sub-battery pack and a second sub-battery pack which are connected in parallel to each other. The common switch may be provided for each of the first and second sub-battery packs. The common electric energy storage may be shared by the first and second sub-battery packs. This results in a decrease in production cost of the charge/discharge system.

The common charge/discharge controller may work to control operations of the switches for the first and second sub-battery packs to transfer electric energy from one of the first and second sub-battery packs to the other through the common electric energy storage. This enablers the electric energy to be shuttled between the two sub-battery packs.

Each of the in-module charge/discharge controllers may measure a voltage, as developed across terminals of each of the battery cells to control an operation of a corresponding one of the in-module switches. This enables measurements of the voltages to be synchronized when they are compared in level with each other, thus resulting in improved accuracy in comparison among the voltages even when the amount of current discharged from or charged into the battery pack varies greatly.

Each of the in-module charge/discharge controllers may serve to measure a voltage, as developed across terminals of a corresponding one of the in-module electric energy storages to control the operation of a corresponding one of the in-module switches.

The common charge/discharge controller may measure a voltage, as developed across terminals of the common electric energy storage to the operation of the common switch.

The charge/discharge system may also include a low-pass filter disposed between each of the in-module electric energy storages and a corresponding one of the in-module charge/discharge controllers.

The charge/discharge system may also include Zener diodes connected to the in-module charge/discharge controllers in parallel to the in-module electric energy storages, respectively, and switches which work to selectively open or close connections between the in-module electric energy storages and the Zener diodes, respectively. Specifically, when the connection between the in-module electric energy storage and the Zener diode is closed, the voltage at which the in-module electric energy storage is charged will be kept at a breakdown voltage of the Zener diode. Alternatively, when the connection between the in-module electric energy storage and the Zener diode is opened, the voltage at which the in-module electric energy storage may be elevated above the breakdown voltage of the Zener diode.

Each of the in-module charge/discharge controllers may measure the voltage, as developed across terminals of the one of the in-module electric energy storages while the one of the in-module electric storages are in connection with one of the battery cells. This avoids an undesirable change in voltage at the in-module electric storage arising from the measurement thereof to improve the accuracy in determining the voltage at the in-module electric energy storage.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which illustrates a charge/discharge system according to the first embodiment;

FIG. 2 is a circuit diagram which illustrates an internal structure of a regulator unit installed in each module of a battery pack of the charge/discharge system of FIG. 1;

FIG. 3 is a flowchart of a program to be executed by the regulator unit of FIG. 2 to minimize a variation in terminal voltage among battery cells of each module;

FIG. 4 is a flowchart of a program to be executed by the charge/discharge system of FIG. 1 to minimize a variation in terminal voltage among modules of a battery pack;

FIG. 5(a) is a graph which represents electric currents discharged from battery cells;

FIG. 5(b) is a graph which represents variations in terminal voltage at battery cells unregulated by the charge/discharge system of FIG. 1;

FIG. 5(c) is a graph which represents variations in terminal voltage at battery cells regulated by the charge/discharge system of FIG. 1;

FIG. 6 is a flowchart of a program to be executed by an in-module regulator unit of a charge/discharge system of the second embodiment;

FIG. 7 is a circuit diagram which illustrates a charge/discharge system of the third embodiment which is mounted in an automotive vehicle;

FIG. 8 is a graph which represents variations in cell voltage of a first and a second battery packs in the charge/discharge system of FIG. 7;

FIG. 9 is a circuit diagram which illustrates an internal structure of the charge/discharge system of FIG. 7;

FIG. 10 is a flowchart a program to be executed by the charge/discharge system of FIG. 7 to control the charging or discharging of a first and a second high-voltage battery packs;

FIG. 11 is a partial circuit diagram which illustrates a charge/discharge system of the fourth embodiment;

FIG. 12 is a circuit diagram which illustrates a charge/discharge system of the fifth embodiment;

FIG. 13 is a flowchart of a program to be executed by the charge/discharge system of FIG. 12;

FIG. 14 is a timechart which illustrates a sequence of on/off operations of switching devices of a charge/discharge system of the sixth embodiment;

FIG. 15 is a circuit diagram which illustrates a modification of an in-module regulator unit of a charge/discharge system;

FIG. 16 is a timechart of a charge/discharge operation of a modification of a charge/discharge system; and

FIG. 17 is a time chart of a fail-safe operation of a modification of a charge/discharge system.

### DESCRIPTION OF THE PREFERRED EMBODIMENTS

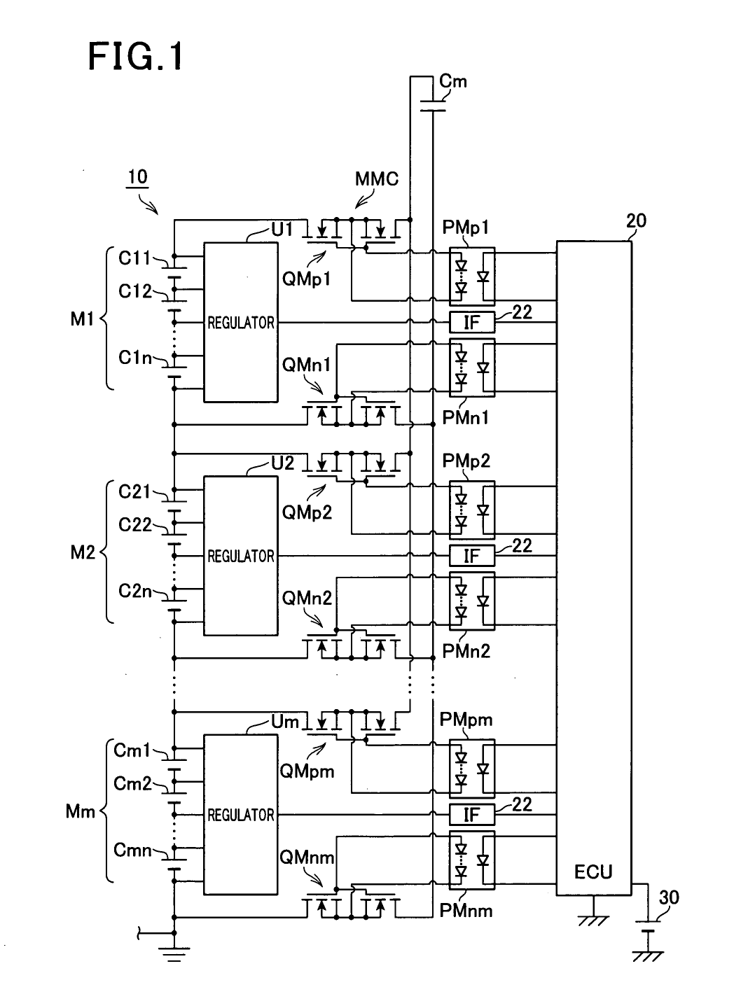

Referring to the drawings, wherein like reference numbers refer to like parts in several views, particularly to FIG. 1, there is shown a charge/discharge system according to the first embodiment which is engineered as a state-of-charge controller to control a state-of-charge (SOC) of a high-voltage battery assembly 10. The high-voltage battery assembly 10, as referred to herein, is mounted in an automotive vehicle.

The high-voltage battery assembly 10 is made up of a plurality of battery cells C11 to Cmn which are connected in series. The high-voltage battery assembly 10 which will also be referred to as a battery pack below) is designed to have a terminal voltage (i.e., the voltage developed across output terminals) of hundred voltage or more. A positive and a negative pole of the battery pack 10 are connected to input terminals of a power converter coupled with, for example, an electric motor used in driving the vehicle. Each of the battery cells C11 to Cmn (which will also be generally denoted by Cij (i=1 to m, j=1 to n) below) is a secondary battery (also called a rechargeable battery) such as a lithium-ion battery. The battery cells C11 to Cmn are substantially identical with each other except for an individual variability thereof. Specifically, the battery cells C11 to Cmn are identical, in relation of an open terminal voltage (i.e., the voltage at terminals when being opened) to the state-of-charge (i.e., a percentage of the current amount of charge to a full amount of charge), full capacity, and internal resistance with each other.

The potential at the negative pole of the battery pack 10 is set to be different from the potential at the body of the vehicle. Specifically, a value intermediate between potentials at the positive pole and the negative pole of the battery pack 10 is set to the potential at the body of the vehicle. This setting is achieved by arranging a pair of series-connected capacitors and a pair of series-connected resistors between the positive and negative poles of the battery pack 10 and coupling joints between the capacitors and between the resistors to the body of the vehicle.

The battery cells C11 to Cmn are broken down into groups (which will also be referred to battery assemblies or modules below) each of which is made up of adjacent n of the battery cells C11 to Cmn (n>2). Specifically, the i^{th} module Mi is made up of the battery cells Ci1 to Cin.

Each of the modules M1 to Mn is electrically connectable to a common module capacitor Cm through a common module matrix converter MMC. The common module matrix converter MMC works as a common switch shared by the module M1 and Mm and is equipped with bidirectional switching devices QMp1 to QMpm and QMn1 to QMnm each of which works to selectively open or close the electric connection between a corresponding one of the modules M1 to Mm (i.e., power supply modules) and the common module capacitor Cm (i.e., a module outside power supply). The common module matrix converter MMC works to establish the transmission of electric energy between the module outside power supply and a selected one or some of the power supply modules.

The switching device QMpi works to open or close the electric connection between the positive pole of the i^{th} module Mi and one of terminals of the common module capacitor Cm. The switching device QMni works to open or close the electric connection between the negative pole of the i^{th} module Mi and the other terminal of the common module capacitor Cm. Each of the switching devices QMpi and QMni includes a pair of n-channel MOS field-effect transistors which are so connected as to have body diodes whose forward directions are oriented in opposite directions, thereby eliminating a flow of electric current through the body diodes when the n-channel MOS field-effect transistors are not turned on. More specifically, the n-channel MOS field-effect transistors of each of the switching devices QMpi and QMni are coupled at sources thereof to each other. This is because each of the transistors is driven by a potential at the gate relative to the source thereof, so that both the transistors are actuated by a single on-signal.

The sources of the n-channel MOS field-effect transistors of each of the switching devices QMpi and QMni are short-circuited to each other. Similarly, the gates of the n-channel MOS field-effect transistors of each of the switching devices QMpi and QMni are short-circuited to each other. The source and the gate of each of the switching devices QMpi and QMni are electrically joined to two terminals on the secondary side of a corresponding one of photo-couplers PMp1 to PMPm and PMn1 to PMnm, respectively. The photo-couplers PMpi and PMni are designed to output a voltage signal. This is because no power supply is disposed on the secondary side of the photo-couplers PMpi and PMni to operate the switching devices QMpi and QMni.

An electronic control unit (ECU) 20 is connected to the primary side of the photo-couplers PMpi and PMni. The ECU 20 is supplied with power from a vehicle-mounted accessory battery whose terminal voltage is lower than that of the battery pack 10. An operational reference potential for the ECU 20 is set different from the potential at the negative pole of the battery pack 10. Specifically, the potential at the body of the vehicle is selected to be the operational reference potential.

The electrostatic capacitance of the common module capacitor Cm is so selected that the amount of energy charged in the capacitor Cm is smaller than that in the battery pack 10 when a charging voltage for the capacitor Cm is equal to the terminal voltage at the battery pack 10 when being operating properly. For instance, the electrostatic capacitance of the capacitor Cm is so determined that the amount of energy charged in the capacitor Cm is less than or equal to one-hundred thousandth (1/100,000), preferably one-millionth (1/1,000,000), and higher than or equal to one-300 millionth (1/300,000,000) of that in the battery pack 10 when the charging voltage for the capacitor Cm is equal to the terminal voltage at the battery pack 10 when being operating properly. Note that the amount of energy charged in the battery pack 10, as referred to above, is a minimum value expected at the voltage developed across the terminals (i.e., the terminal voltage) of the battery pack 10 when being operating properly.

The ECU 20 receives signals outputted from in-module regulator units U1 to Um through interfaces 22 to control an operation of the common module matrix converter MMC. The ECU 20 works as a common charge/discharge controller to output instruction signals to the in-module regulator units U1 to Um through the interfaces 22 to regulate the state-of-charge (SOC) in the modules M1 to Mm. The interfaces 22 may be each implemented by a photo-coupler.

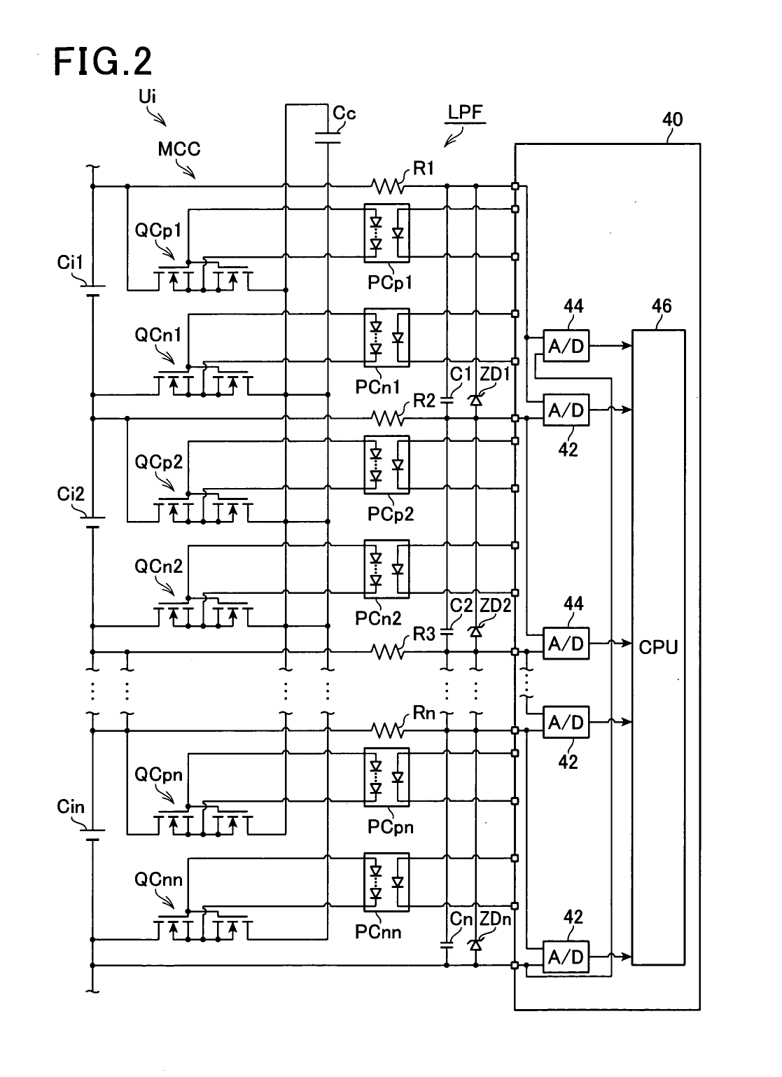

FIG. 2 illustrates an internal structure of each of the in-module regulator units U1 to Um which are generally denoted by “Ui” below.

The in-module regulator unit Ui is equipped with an in-module capacitor Cc and an in-module matrix converter MCC. The electrostatic capacitance of the in-module capacitor Cc is so selected that the amount of energy charged in the capacitor Cm is smaller than that in a corresponding one of the modules M1 to Mm (i.e., the module Mi) when a charging voltage for the capacitor Cc is equal to the terminal voltage at the module Mi when being operating properly. For instance, the capacitance of the capacitor Cc is so determined that the amount of energy charged in the capacitor Cc is less than or equal to one-hundred thousandth (1/100,000), preferably one-millionth (1/1,000,000), and higher than or equal to one-300 millionth (1/300,000,000) of that in the module Mi when the charging voltage for the capacitor Cc is equal to the terminal voltage at the module Mi when being operating properly. Note that the amount of energy charged in the module Mi, as referred to above, is a minimum value expected at the voltage developed across the terminals (i.e., the terminal voltage) of the module Mi when being operating properly.

The in-module matrix converter MCC is equipped with bidirectional switching devices QCp1 to QCpn and QCn1 to QCnn which work to open or close electric connections between power supply modules (i.e., the battery cells Ci1 to Cin) and a module outside power supply (i.e., the in-module Cm), respectively. The in-module matrix converter MCC work to establish the transmission of electric energy between the module outside power supply and a selected one or some of the power supply modules.

The switching device QCpj works to open or close the electric connection between the positive pole of the battery cell Cij and one of terminals of the in-module capacitor Cc. The switching device QCnj works to open or close the electric connection between the negative pole of the battery cell Cij and the other terminal of the in-module capacitor Cc. Each of the switching devices QCpj and QCnj, like the switching devices QMpi and QMni, includes a pair of n-channel MOS field-effect transistors. The source and the gate of each of the switching devices QCpj and QCnj are electrically joined to terminals on the secondary side of a corresponding one of photo-couplers PCp1 to PCpn and PCn1 to PCnn, respectively. The photo-couplers PCpj and PCnj are like the photo-couplers PMpi and PMni, designed to output a voltage signal.

The switching devices QCpj and QCnj of the in-module matrix converter MCC are lower in electric strength (also called voltage resistance or withstand voltage) than the switching devices QMpi and QMni of the common module matrix converter MMC. Similarly, the photo-couplers PCpj and PCnj are lower in electric strength than the photo-couplers PMpi and PMni.

A microcomputer 40 is disposed in the in-module regulator unit Ui and works as an in-module charge/discharge controller. The microcomputer 40 is connected to the primary sides of the photo-couplers PCpj and PCnj. The microcomputer 40 is equipped with a CPU 46 and performs software functions. The microcomputer 40 are connected to the positive and negative poles of the battery cells Ci1 to Cin to measure the terminal voltages appearing at the battery cells Ci1 and Cin, respectively. Specifically, the positive poles of the battery cells Ci1 to Cin are electrically coupled to the microcomputer 40 through resistors R1 to Rn, respectively, while the negative poles of the battery cells Ci1 to Cin are electrically coupled to the microcomputer 40 without any resistors. Capacitors C1 to Cn are also connected to the battery cells Ci1 to Cin through the resistors R1 to Rn, respectively. The resistor Rj and the capacitor Cj constitute an RC circuit with a low-pass filter LPF.

In addition to the RC circuit composed of the resistor Ri and the capacitor Cj, an RC circuit which is made up of the resistor R1 and the capacitors C1 to Cn is also provided. The first RC circuit (i.e., the resistor Ri and the capacitor Cj) serves to output the terminal voltage at the battery cell Cij (i.e., each of the battery cells Ci1 to Cin) to the microcomputer 40. The microcomputer 40 converts such a voltage output into a digital form through a corresponding one of analog-to-digital (A/D) converters 42 and inputs it into the CPU 46. The second RC circuit (i.e., the resistor R1 and the capacitors C1 to Cn) serves to output the terminal voltage at the module Mi to the microcomputer 40. The microcomputer 40 converts such a voltage output into a digital form through an analog-to-digital (A/D) converter 44 and inputs it into the CPU 46. The CPU 46 outputs the terminal voltages at each of the battery cells Ci1 to Cin and the module Mi in the form of digital signals to the ECU 20 through a corresponding one of the interfaces 22, as illustrated in FIG. 1.

The electric strength of each of the A/D converters 42 is lower than a maximum value of the terminal voltage at the module Mi. In order to protect the A/D converter 42 from excessive high voltages, Zener diodes ZD1 to ZDn are connected in parallel to the capacitors C1 to Cn, respectively. The breakdown voltage of the Zener diodes ZD1 to ZDn is greater than an expected maximum value of the terminal voltage at the battery cells Cij and lower than the withstand voltage of the A/D converters 42.

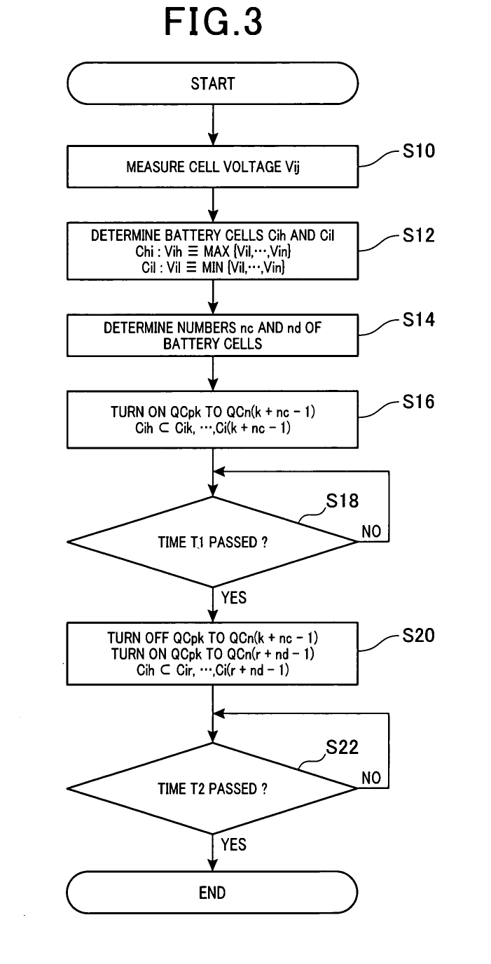

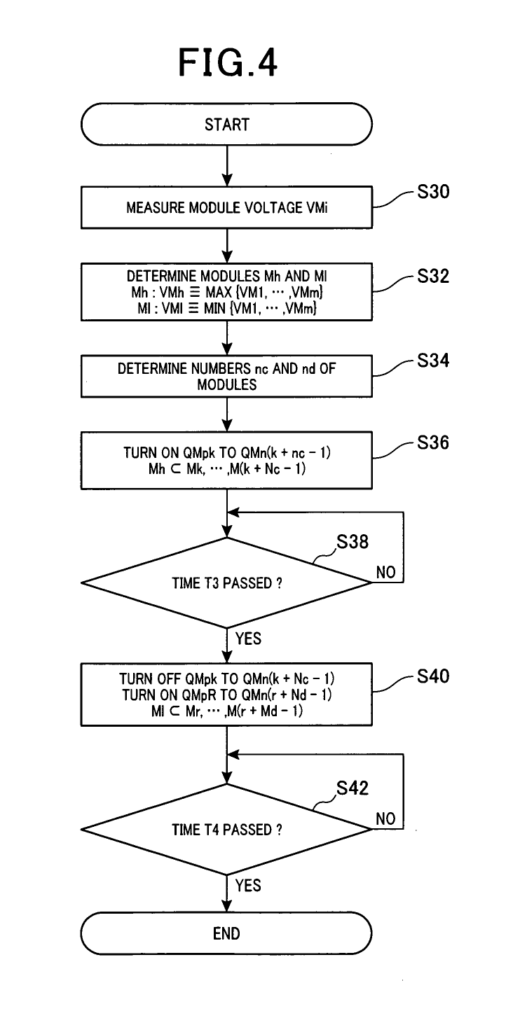

FIGS. 3 and 4 illustrate sequences of logical steps of programs to be executed to control the SOC in the battery cells C11 to Cmn to regulate a variation in terminal voltage among the battery cells C11 to Cmn. Specifically, such regulation is accomplished by two operations: one being to decrease a variation in terminal voltage among the battery cells Ci1 to Cin of the module Mi, and the second being to decrease a variation in terminal voltage among the modules M1 to Mm.

The program of FIG. 3 is to perform the first operation, as described above, to decrease or eliminate a variation in terminal voltage among the battery cells Ci1 to Cin of the module Mi. This program is executed at a regular interval in the in-module regulator unit Ui in response to an instruction from the ECU 20.

After entering the program of FIG. 3, the routine proceeds to step S10 wherein voltages Vi1 to Vin developed at the battery cells Ci1 to Cin of the module Mi are measured, respectively. This measurement is achieved by a corresponding one of the A/D converters 42. The routine then proceeds to step S12 wherein a battery cell Cih that is one of the battery cells Ci1 to Cin whose terminal voltage is the greatest and a battery cell Ci1 that is one of the battery cells Ci1 to Cin whose terminal voltage is the smallest are specified.

The routine proceeds to step S14 wherein the number nc of ones of the battery cells Ci1 to Cin of the module Mi (which will also be referred to as a cell used number nc below) which are to be used in charging the in-module capacitor Cc is determined. The ones of the battery cells Ci1 to Cin are also specified. Specifically, the battery cell Cih and one or two or more of the battery cells Ci1 to Cin which is or are connected adjacent the battery cell Cih are selected, For instance, when the battery cell Cih is the battery cell Ci3, and the number nc is three, a combination of the battery cell Ci3 and the battery cells Ci1 and Ci2, a combination of the battery cell Ci3 and the battery cells Ci2 and Ci4, or a combination of the battery cell Ci3 and the battery cells Ci4 and Ci5 is selected. Additionally, the number nd of ones of the battery cells Ci1 to Cin of the module Mi (which will also be referred to as a cell used number nd below) to which the electric energy is to be released from the in-module capacitor Cc is determined. The ones of the battery cells Ci1 to Cin are also specified in the same manner as the selection of the number nc of the battery cells Ci1 to Cin. The cell used number nd is smaller than the cell used number nc. The cell used numbers nd and nc are so selected that a value of nc−nd may increase with an increase in required amount of charge into the nd battery cells Ci1 to Cin in a cycle in which the operation to couple the nc battery cells Ci1 to Cin to the in-module capacitor Cc and the operation to couple the nd battery cells Ci1 to Cin to the in-module capacitor Cc are performed.

The routine proceeds to step S16 wherein the nc battery cells Ci1 to Cin, as selected in step S14, including the battery cell Cih whose terminal voltage is the greatest (which will also be referred to as battery cells Cik, Ci(k+1), . . . Ci(k+nc−1) below) are electrically connected to the in-module capacitor Cc. This is achieved by turning on only the switching devices QCpk to QCn(k+nc−1) of the in-module matrix converter MCC. This causes the electric current to flow from the battery cells Cik, Ci(k+1), . . . Ci(k+nc−1) to the in-module capacitor Cc. The current flowing into the in-module capacitor Cc is restricted by internal resistances of the battery cells Cik, Ci(k+1), . . . Ci(k+nc−1) and resistances of the switching devices QCpk to QCn(k+nc−1). The excess of current charged in the in-module capacitor Cc is avoided by the selection of the capacitance thereof, as described above. Specifically, the rate at which a charging voltage, which is the voltage at which the in-module capacitor Cc is charged, changes is increased by decreasing the amount of energy to be stored in the in-module capacitor Cc to be much smaller than that in the module Mi when the charging voltage for the in-module capacitor Cc is identical with the terminal voltage at the module Mi, thereby controlling the excess of current charged in the in-module capacitor Cc. In this embodiment, the switching devices QCpk to QCn(k+nc−1) are used in an operating range in which the current actually flowing through the switching devices QCpk to QCn(k+nc−1) is smaller than a maximum possible current which is allowed to flow through the switching devices QCpk to QCn(k+nc−1) in order to reducing an energy loss.

The operation in step S16 is executed for a given period of time T1. Specifically, in step S18, it is determined whether the period of time T1 has expired or not. The period of time T1 is set to a length of time required to transfer the electric energy in the battery cells Cik, Ci(k+1), . . . Ci(k+nc−1) to the in-module capacitor Cc completely.

If a YES answer is obtained in step S18 meaning that the period of time T1 has expired, then the routine proceeds to step S20 wherein the rid battery cells Ci1 to Cin, as selected in step S14, including the battery cell Ci1 whose terminal voltage is the smallest (which will also be referred to as battery cells Cir, Ci(r+1), . . . Ci(r+nd−1) below) are electrically connected to the in-module capacitor MCC. This is achieved by turning off the switching devices QCpk to QCn(k+nc−1), while turning on the switching devices QCpr to QCn(r+nd−1) of the in-module matrix converter MCC. This causes the electric current to flow from the in-module capacitor Cc to the battery cells Cir, C(r+1), . . . Ci(r+nd−1). The operation in step S20 is executed for a given period of time T2. Specifically, in step S22, it is determined whether the period of time T2 has expired or not. The period of time T2 is set to a length of time required to transfer the electric energy from the in-module capacitor Cc to the battery cells Cir, Ci(r+1), . . . Ci(r+nd−1).

If a YES answer is obtained in step 522 meaning that the period of time T2 has expired, then the routine terminates.

FIG. 4 illustrates the program, as described above, to decrease or eliminate a variation in terminal voltage among the modules M1 to Mm. The program is executed at a regular interval by the ECU 20.

After entering the program of FIG. 4, the routine proceeds to step 530 wherein voltages VM1 to VMm developed at the modules M1 to Mm are measured. Specifically, the terminal voltage VMi appearing at the module Mi is measured by the in-module regulator unit Ui.

The routine proceeds to step S32 wherein a module Mh that is one of the modules M1 to Mm whose terminal voltage is the greatest and a module M1 that is one of the modules M1 to Mm whose terminal voltage is the smallest are specified.

The routine proceeds to step S34 wherein the number Nc of ones of the modules M1 to Mm which are to be used in charging the common module Cm is selected. The ones of the modules M1 to Mm are also specified. Specifically, the module Mh and one or two or more of the modules M1 to Mm which is or are connected adjacent the module Mh are selected. For instance, when the module Mh is the module M3, and the number Nc is three, a combination of the module M3 and the modules M1 and M2, a combination of the module M3 and the modules M2 and M4, or a combination of the module M3 and the modules M4 and M5 is selected. Additionally, the number Nd of ones of the modules M1 to Mm to which the electric energy is to be released from the in-module capacitor Cm is determined. The ones of the modules M1 to Mm are also specified in the same manner as the selection of the number Nc of the modules M1 to Mm. The number Nd is smaller than the number Na. The numbers Nc and Nd are so selected that a value of Nc−Nd may increase with an increase in required amount of charge into the Nd modules M1 to Mm in a cycle in which the operation to couple the Nc modules M1 to Mm to the common module capacitor Cm and the operation to couple the Nd modules M1 to Mm to the common module capacitor Cm are performed.

The routine proceeds to step S36 wherein the Nc modules M1 to Mm, as selected in step S34, including the module Mh whose terminal voltage is the greatest (which will also be referred to as modules Mk, M(k+1), . . . M(k+Nc−1) below) are electrically connected to the common module capacitor Cm. This is achieved by turning on only the switching devices QMpk to QMn(k+Nc−1) of the common module matrix converter MMC. This causes the electric current to flow from the modules Mk, M(k+1), . . . M(k+Nc−1) to the common module capacitor Cm. The current flowing into the common module capacitor Cm is restricted by internal resistances of the modules Mk, M(k+1), . . . M(k+Nc−1) and resistances of the switching devices QMpk to QMn(k+Nc−1). The excess of current charged in the common module capacitor Cm is avoided by the selection of the capacitance thereof, as described above. Specifically, the rate at which a charging voltage, which is the voltage at which the common module capacitor Cm is charged, changes is increased by decreasing the amount of energy to be stored in the common module capacitor Cm to be much smaller than that in the battery pack 10 when the charging voltage for the common module capacitor Cm is identical with the terminal voltage at the battery pack 10, thereby controlling the excess of current charged in the common module capacitor Cm. In this embodiment, the switching devices QMpk to QMn(k+Nc−1) are used in an operating range in which the current actually flowing through the switching devices QMpk to QMn(k+Nc−1) is smaller than a maximum possible current which is allowed to flow through the switching devices QMpk to QMn(k+Nc−1) in order to reducing an energy loss.

The operation in step S36 is executed for a given period of time T3. Specifically, in step S38, it is determined whether the period of time T3 has expired or not. The period of time T3 is set to a length of time required to transfer the electric energy in the modules Mk, M(k+1), . . . M(k+Nc−1) to the common module capacitor Cm completely.

If a YES answer is obtained in step S38 meaning that the period of time T3 has expired, then the routine proceeds to step S40 wherein the Nd modules M1 to Mm, as selected in step S34, including the module M1 whose terminal voltage is the smallest (which will also be referred to as modules Mr, M(r+1), . . . M(r+Nd−1) below) are electrically connected to the common module capacitor Cm. This is achieved by turning off the switching devices QMpk to QM(k+Nc−1) while turning on the switching devices QMpr to QMn(r+Nd−1) of the common module matrix converter MMC. This causes the electric current to flow from the common module capacitor Cm to the modules Mr, M(r+1), . . . M(r+Nd−1). The operation in step S40 is executed for a given period of time T4. Specifically, in step S42, it is determined whether the period of time T4 has expired or not. The period of time T4 is set to a length of time required to transfer the electric energy from the common module capacitor Cm to the modules Mr, M(r+1), . . . M(r+Nd−1) completely.

If a YES answer is obtained in step S42 meaning that the period of time T4 has expired, then the routine terminates.

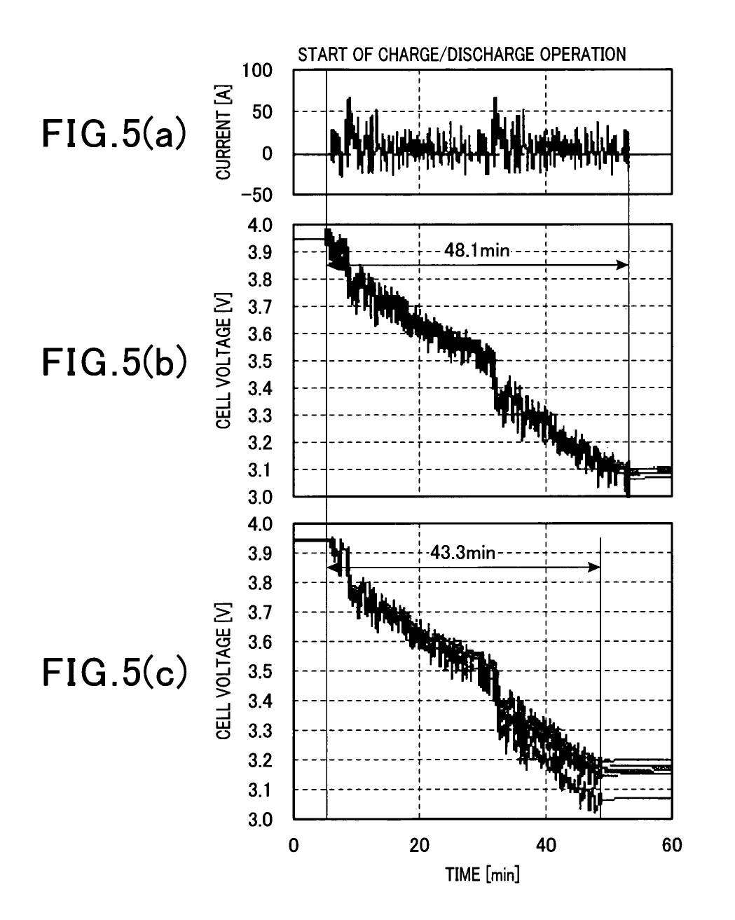

FIGS. 5(a), 5(b), and 5(c) demonstrate results of tests conducted concerning techniques employed in the above embodiment. The tests were performed on a charge/discharge system in which electric current, which is expected when an automobile is running, flows through six battery cells coupled in series with each other. FIG. 5(a) represents electric currents discharged from the battery cells. FIG. 5(b) represents variations in terminal voltage at the battery cells unregulated by the charge/discharge system. FIG. 5(c) represents variations in terminal voltage at the battery cells regulated by the charge/discharge system.

The graphs of FIGS. 5(a) to 5(c) show that the regulation of the variation in terminal voltage made by the charge/discharge system results in an increase in time it takes the terminal voltage at at least one of the battery cells to reach a lower limit. This enables a travel distance of the vehicle to be prolonged.

The charge/discharge system of the embodiment offers the following advantages.

1) The charge/discharge system is, as described above, equipped with the common module capacitor Cm and the common module matrix converter MMC which serve to minimize a variation in terminal voltage among the modules M1 to Mm without wasting the electric energy in the module M1 to Mm on conversion into thermal energy.
2) The in-module regulator unit Ui of each of the modulators M1 to Mm is equipped with the in-module capacitor Cc and the in-module matrix converter MCC which serve to minimize a variation in terminal voltage among the battery cells Ci1 to Cin without wasting the electric energy in the battery cells Ci1 to Cin on conversion into thermal energy.
3) A combination of the common module capacitor Cm, the common module matrix converter MMC, the in-module capacitors Cc, and the in-module matrix converters MCC works to minimize a variation in terminal voltage among all the battery cells C11 to Cmn of the battery pack 10.
4) The number nc of ones of the battery cells Ci1 to Cin of the module Mi which are to be used in charging the in-module capacitor Cc and the number nd of ones of the battery cells Ci1 to Cin of the module Mi to which the electric energy is to be released from the in-module capacitor Cc are determined variably, in other words, the difference between the number nc and the number nd is selected variably, thereby enabling the amount of charge to the selected ones of the battery cells Ci1 to Cin to be controlled per time unit.
5) The number Nc of ones of the modules M1 to Mm which are to be used in charging the common module Cm and the number Nd of ones of the modules M1 to Mm to which the electric energy is to be released from the in-module capacitor Cm are determined variably, thereby enabling the amount of charge to the selected ones of the modules M1 to Mm to be controlled per time unit.
6) The in-module regulator unit Ui is equipped the A/D converters 42 each of which measures the voltage (i.e., the terminal voltage) appearing at one of the battery cells Ci1 to Cin. This enables measurements of the terminal voltages to be synchronized when they are compared in level with each other, thus resulting in improved accuracy in comparison among the terminal voltages even when the amount of current discharged from or charged into the battery pack 10 varies greatly.
7) The use of the common module matrix converter MMC and the in-module matrix converters MCC results in a decrease in high voltage resistance parts (i.e., the switching devices QMpi and QMni).
8) Each of the switching devices QMpi and QMni is short-circuit at sources thereof to each other, thereby enabling a single on/off signal to be used to operate each of the switching devices QMpi and QMni. The same is true for the switching devices QCpj and QCni.
9) The on/off signal to each of the switching devices QMpi and QMni is provided in the form of voltage by an insulated signal transmitting device (e.g., the photo-coupler PMpi), thereby eliminating the need for a power supply on the secondary side to turn on or off the switching devices QMpi and QMni. The same applies to the switching devices QCpj and QCnj.

The charge/discharge system of the second embodiment will be described below which is designed to decrease or minimize a variation in charged percentage (i.e., a state of charge) or charged capacity (also called charged ampere-hour) instead of the minimization of a variation in terminal voltage among the battery cells Ci1 to Cin or the modules M1 to Mm.

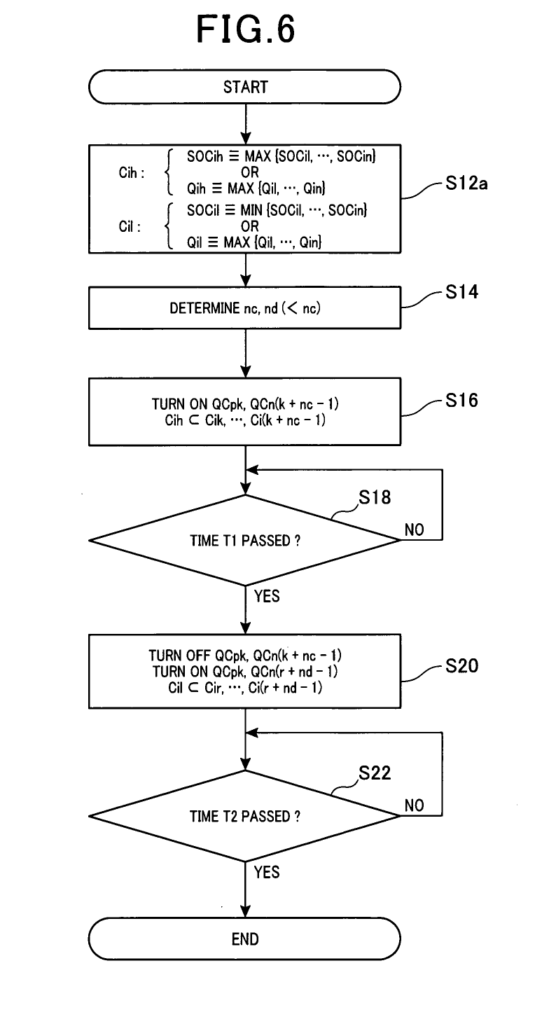

FIG. 6 shows a program to be executed at a regular interval in the in-module regulator unit Ui in response to an instruction from the ECU 20 to control a variation in charged percentage or charged capacity in the module Mi. The same step numbers, as employed in FIG. 3, refer to the same operations, and explanation thereof in detail will be omitted here.

After entering the program of FIG. 6, the routine proceeds to step S12a wherein a battery cell Cih that is one of the battery cells Ci1 to Cin whose state of charge (SOC) is the greatest of SOCi1 to SOCin and a battery cell Ci1 that is one of the battery cells Ci1 to Cin whose SOC is the smallest of SOCi1 to SOCin are specified. Alternatively, a battery cell Cih that is one of the battery cells Ci1 to Cin whose charged capacity is the greatest of Qi1 to Qin and a battery cell Ci1 that is one of the battery cells Ci1 to Cin whose charged capacity is the smallest of Qi1 to Qin are specified. The SOC of each of the battery cell Ci1 to Cin may be determined by calculating an open terminal voltage based on a measured value of closed terminal voltage, the amount of current, an internal resistance thereof and looking up one of SOCs listed in a map which corresponds to the calculated open terminal voltage. The charged capacity of each of the battery cells Ci1 to Cin may be determined by multiplying the SOC by a full charge capacity thereof.

After step S12, steps S14, S16, S18, S20, and S22 which are substantially the same in operations as those in FIG. 3 except for use of the SOC or charged capacity instead of the terminal voltage are performed. The same operations as those in FIG. 6 may be made to minimize a variation in charged percentage or charged capacity among the modules M1 to Mm.

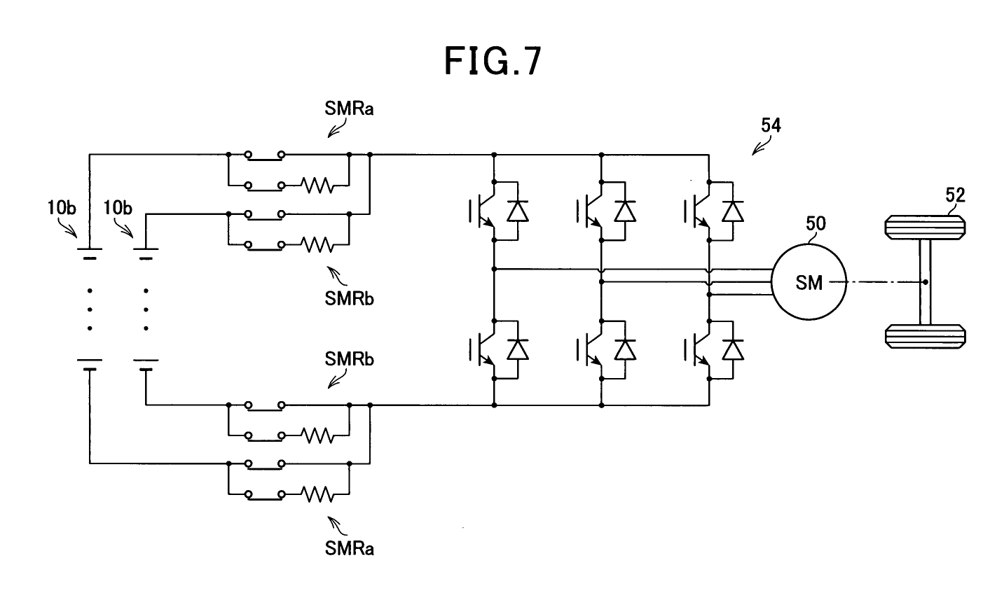

FIG. 7 shows a charge/discharge system of the third embodiment which is mounted in an automotive vehicle.

The charge/discharge system includes a battery pack made up of two sub-battery packs: a first high-voltage battery pack 10a and a second high-voltage battery pack 10b which are mounted in the vehicle in parallel connection to an inverter 54. The inverter 54 is electrically connected to a motor-generator 50 to which driven wheels 52 are mechanically joined. An electric connection between the inverter 54 and the first high-voltage battery pack 10a is selectively opened or closed by relays SMRa. An electric connection between the inverter 54 and the second high-voltage battery pack 10b is selectively opened or closed by relays SMRb.

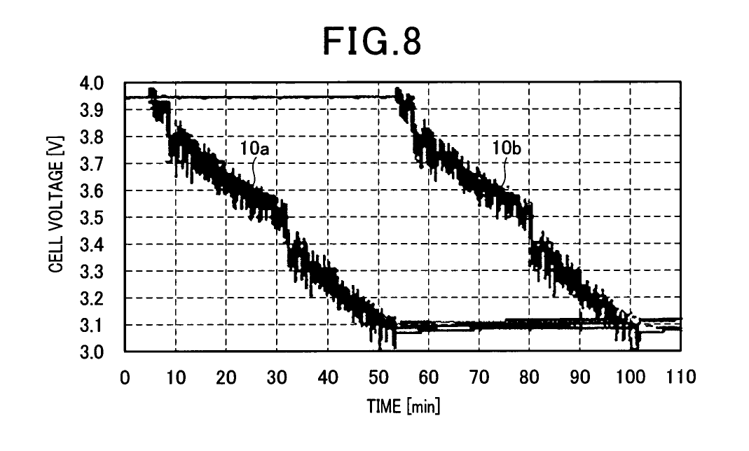

The charge/discharge system of this embodiment is, as can be seen from FIG. 8, engineered to establish the electric connection of either one of the first and second high-voltage battery packs 10a and 10b to the inverter 54 and switch from the one of the first and second high-voltage battery packs 10a and 10b to the other through relays SMRs and SMRb when the level of voltage at the former has reached a lower limit.

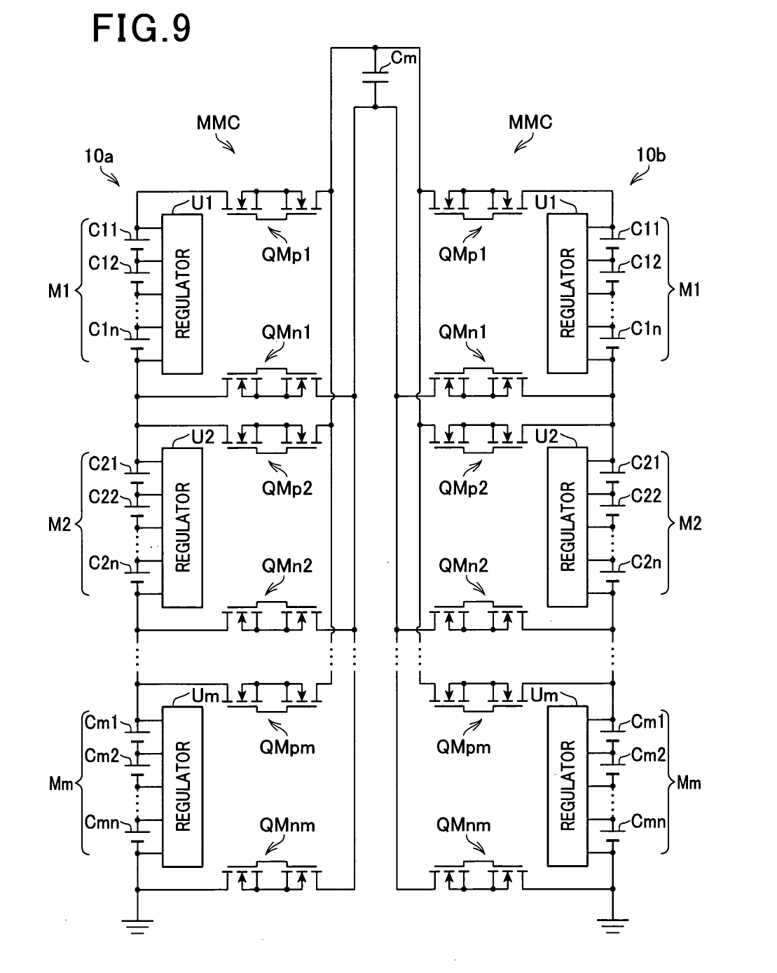

FIG. 9 illustrates the charge/discharge system of the third embodiment serving as a state-of-charge regulator. The same reference numbers as employed above refer to the same parts, and explanation thereof in detail will be omitted here.

The first high-voltage battery pack 10a is equipped with the in-module regulator units U1 to Um and the common module matrix converter MMC. Similarly, the second high-voltage battery pack 10b is equipped with the in-module regulator units UT to Urn and the common module matrix converter MMC. The common module matrix converter MMC of each of the first and second high-voltage packs 10a and 10b is substantially identical in structure with the one as illustrated in FIG. 1, and controlled by the ECU 20. The common module capacitor Cm is shared between the first and second high-voltage battery packs 10a and 10b. FIG. 9 omits the ECU 20 for the brevity of illustration.

The charge/discharge system works to shuttle electric energy from one of the first and second high-voltage battery packs 10a and 10b to the other using the common module capacitor Cm. It is useful to actuate the charge/discharge system in a regeneration mode of an operation of the vehicle in order to increase the amount of charge to the first high-voltage battery pack 10a or the second high-voltage battery pack 10b using the regenerative energy (i.e. braking energy).

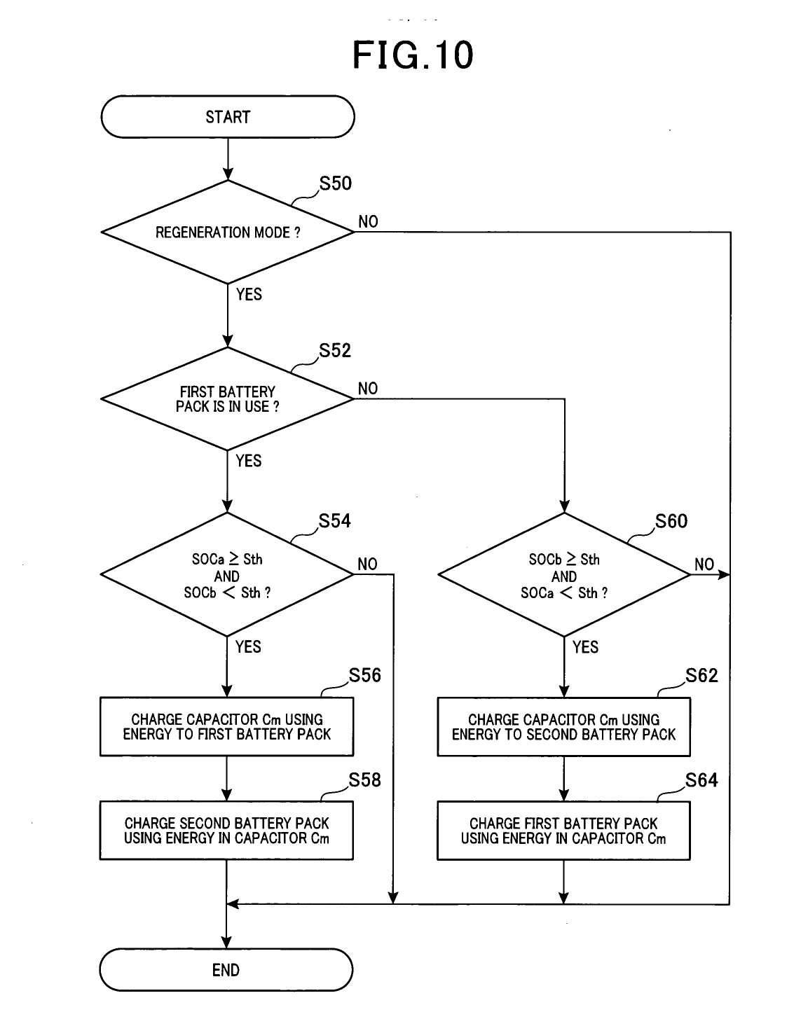

FIG. 10 shows a flowchart of a program to be executed at a regular interval in the in-module regulator unit Ui in response to an instruction signal from the ECU 20 to control the charging or discharging of the first and second high-voltage battery packs 10a and 10b.

First, in step S50, it is determined whether the vehicle is in the regeneration mode or not. If a YES answer is obtained, for example, meaning that vehicle is decelerating, then the routine proceeds to step S52 wherein the first high-voltage battery pack 10a is in use or not. If a YES answer is obtained, then the routine proceeds to step S54 wherein it is determined whether a condition in which the state of charge SOCa of the first high-voltage battery pack 10a is greater than or equal to a given threshold value Sth, and the state of charge SOCb of the second high-voltage battery pack 10b is less than the threshold value Sth is met or not. This determination is made to determine whether the first high-voltage battery pack 10a is not permitted to be charged with regenerative energy, while the second high-voltage battery pack 10b has a capacity enough to absorb the regenerative energy or not. The threshold value Sth is selected to be a lower limit of the state of charge of the first and second high-voltage battery packs 10a and 10b at which the terminal voltage at any of the battery cells C11 to Cmn reaches an upper limit thereof. The threshold value Sth may be changed as a function of a degree of torque permitted to be applied to the driven wheels 52 in the regeneration mode.

If a YES answer is obtained in step S54, then the routine proceeds to steps S56 and S58 to the electric energy flowing from the inverter 54 to the first high-voltage battery pack 10a is transferred to charge the second high-voltage battery pack 10b. Specifically, in step S56, the terminal of the first high-voltage battery 10a is electrically connected to the common module capacitor Cm. This is achieved by turning on the switching devices QMp1 and QMnm for the first high-voltage battery pack 10a. Subsequently, in step S58, the common module capacitor Cm is electrically connected to the second high-voltage battery pack 10b. This is achieved by turning off the switching devices QMp1 and QMnm for the first high-voltage battery pack 10a while turning on the switching devices QMp1 and QMnm for the second high-voltage battery pack 10b. Alternatively, one or some of the modules M1 to Mm of the second high-voltage battery pack 10b may be connected to the common module capacitor Cm.

If a NO answer is obtained in step S52 meaning that the first high-voltage battery pack 10a is not in use, then the routine proceeds to step S60 wherein it is determined whether a condition in which the state of charge SOCb of the second high-voltage battery pack 10b is greater than or equal to the threshold value Sth, and the state of charge SOCa of the first high-voltage battery pack 10a is less than the threshold value Sth is met or not. This determination is made to determine whether the second high-voltage battery pack 10b is not admitted to be charged with the regenerative energy, while the first high-voltage battery pack 10a has a capacity enough to absorb the regenerative energy or not.

If a YES answer is obtained, then the routine proceeds to step S62 then the routine proceeds to steps S62 and S64 to the electric energy flowing from the inverter 54 to the second high-voltage battery pack 10b is transferred to charge the first high-voltage battery pack 10a. Specifically, in step S62, the terminal of the second high-voltage battery 10b is electrically connected to the common module capacitor Cm. This is achieved by turning on the switching devices QMp1 and QMnm for the second high-voltage battery pack 10b. Subsequently, in step S64, the common module capacitor Cm is electrically connected to the first high-voltage battery pack 10a. This is achieved by turning off the switching devices QMp1 and QMnm for the second high-voltage battery pack 101) while turning on the switching devices QMp1 and QMnm for the first high-voltage battery pack 10a. Alternatively, one or some of the modules M1 to Mm of the first high-voltage battery pack 10a may be connected to the common module capacitor Cm.

After step S58 or S64 or if a NO answer is obtained in step S50, S54, or S60, the routine terminates.

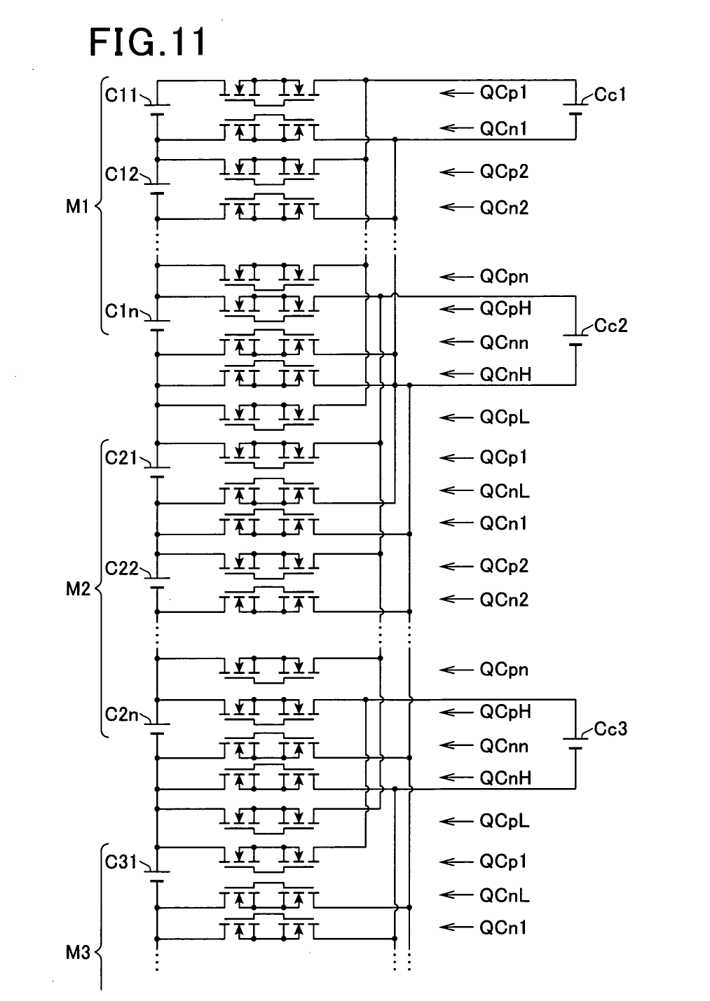

FIG. 11 shows a charge/discharge system of the fourth embodiment serving as a state-of-charge regulator. The same reference numbers as employed in the above embodiment refer to the same parts, and explanation thereof in detail will be omitted here. FIG. 11 omits the ECU 20 for the brevity of illustration.

As can be seen from FIG. 11, a combination of the battery cells Ci1 to Cin of each of the modules M1 to Mn and one or some of the battery cells Ci1 to Cin of an immediately closest neighbor one or two of the modules M1 to Mm constitutes a sub-battery assembly. Each of the sub-battery assemblies is equipped with a matrix converter and one of in-module capacitors Cc1 to Ccm. Specifically, a combination of all the battery cells C11 to C1n of the first module M1 and the battery cell C21 that is one of the battery cells C21 to C2n of the second module M2 forms the sub-battery assembly leading to the in-module capacitor Cc1. A combination of the battery cell C1n of the first module M1, all the battery cells C21 to C2n of the second module M2, and the battery cell C31 that is one of the battery cells C31 to C3n of the third module M3 forms the sub-battery assembly leading to the in-module capacitor Ca. The same is true for other modules M3 to Mm.

More specifically, the in-module capacitor Cc1 for the first module M1 is connected to the battery cell C1j of the first module M1 through the switching devices QCpj and QCnj. The in-module capacitor Cc1 is also connected to the battery cell C21 of the second module M2 through the switching devices QCpL and QCnL.

The in-module capacitor Cc2 for the second module M2 is connected to the battery cell C2j of the second module M2 through the switching devices QCpj and QCnj. The in-module capacitor Cc2 is also connected to the battery cell C1n of the first module M1 through the switching devices QCpL and QCnL and to the battery cell C31 of the third module M3 through the switching devices QCpL and QCnL.

The above arrangements are operable to establish transmission of electric energy among the battery cells C11 to C1n and C21 through the in-module capacitor Cc1 and among the battery cells C1n, C21 to C2n, and C31 through the in-module capacitor Cc2. Specifically, the electric energy is transmittable among the battery cells Ci1 to Cin of each of the modules M1 to Mm and one or some of the battery cells Ci1 to Cin of an immediately closest neighbor one or two of the modules M1 to Mm through the in-module capacitors CC1 to CCm, thus permitting the electric energy to be transmitted among all the battery cells C11 to Cmn to minimize a variation in terminal voltage, state of charge, or charged capacity among the battery cells C11 to Cmn.

The switching devices QCpj, QCnj, QCpH, QCnH, QCpL, and QCnL may have a required voltage resistance smaller than that of the switching devices QMpi and QMni used in the first embodiment.

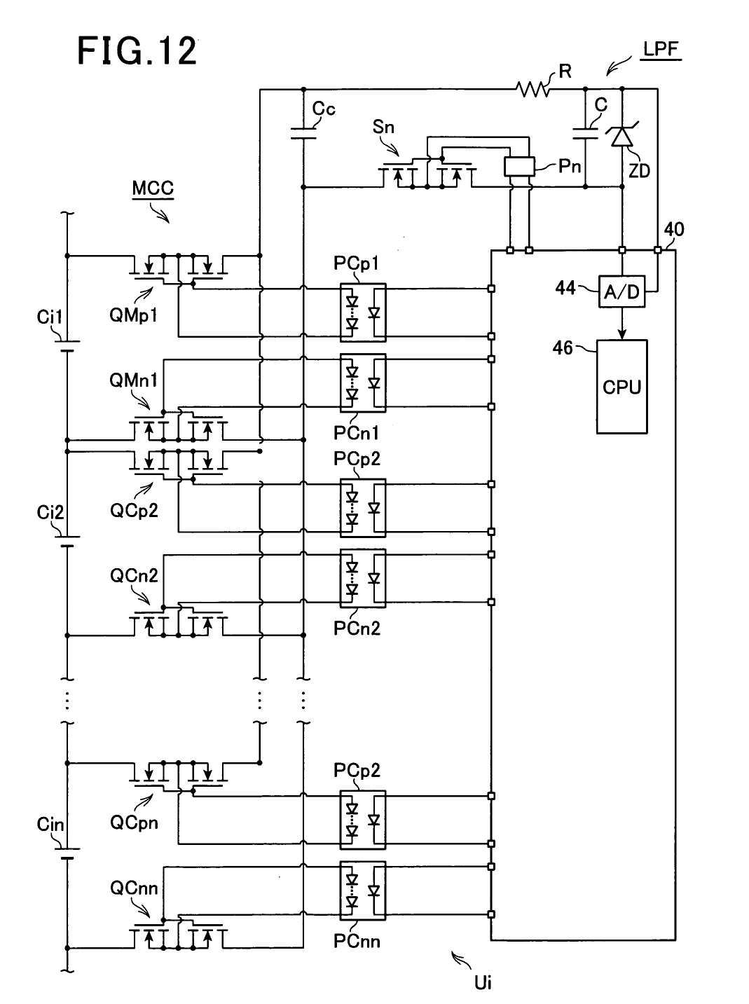

FIG. 12 illustrates the charge/discharge system of the fifth embodiment. The same reference numbers as employed in FIG. 2 refer to the same parts, and explanation thereof in detail will be omitted here.

The charge/discharge system, like in FIG. 2, has the RC circuit (i.e., LPF) made up of the resistor R and the capacitor C. The voltage developed across the terminals of the in-module capacitor Cc is inputted into the A/D converter 44 of the microcomputer 40 through the RC circuit and the Zener diode ZD. In other words, the A/D converter 44 measures the terminal voltage at the battery cells Ci1 to Cin as a charging voltage for the in-module capacitor Cc.

Specifically, the switching device Sn opens or closes the connection between the in-module capacitor Cc and the RC circuit. The switching device Sn is operated by the microcomputer 40 through the photo-coupler P. The switching device Sn is identical in structure with the switching devices QCpj and QCnj. The photo-coupler Pn is identical in structure with the photo-couplers PCpj and PCnj.

The breakdown voltage of the Zener diode ZD is greater than an expected maximum value of the terminal voltage at the battery cell Cij and lower than or equal to the terminal voltage at the module Mi, thereby permitting the withstand voltage of the A/D converters 44 to be decreased greatly. The switching device Sn is used to open the connection between the in-module capacitor Cc and the Zener diode ZD for holding the Zener diode ZD from being turned on when the charging voltage for the in-module capacitor Cc becomes higher than the voltage at the battery cell Cij due to the minimization of a variation in terminal voltage among the battery cells Ci1 to Cin.

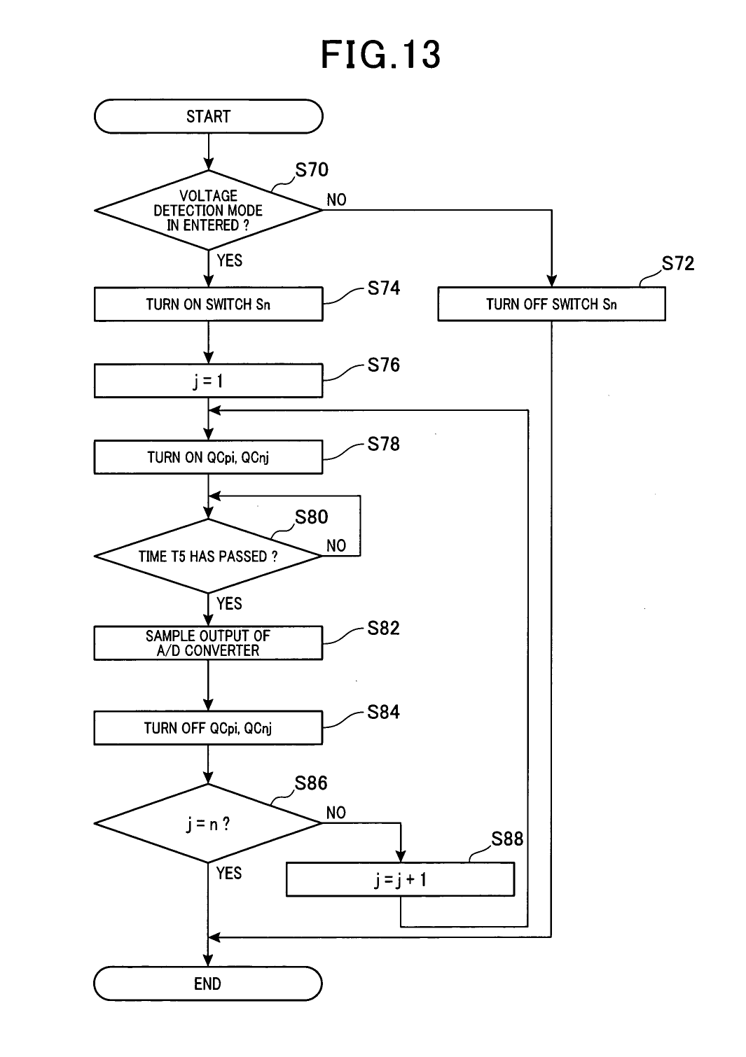

FIG. 13 shows a program to be executed at a regular interval in the in-module regulator unit Ui in response to an instruction signal from the ECU 20 to measure the voltage appearing at the battery cell Cij.

After entering the program, the routine proceeds to step S70 wherein it is determined whether a voltage detection mode in which the voltage developed at the battery cell Cij is to be detected is entered or not. If a NO answer is obtained meaning that the voltage detection mode is not entered, then the routine proceeds to step S72 wherein the switching device Sn is turned off to avoid the application of charging voltage for the in-module capacitor Cc to the Zener diode ZD. The routine then terminates.

Alternatively, if a YES answer is obtained in step S70, then the routine proceeds to step S74 wherein the switching device Sn is turned on to connect the terminals of the in-module capacitor Cc to the A/D converter 44.

The routine proceeds to step S76 wherein a parameter j identifying the battery cell Cij (i.e., one of the battery cells Ci1 to Cin) of the module Mi is set to one (1). The routine proceeds to step S78 wherein the switching devices QCpj and QCnj are turned on for measuring the voltage appearing across the terminals of the battery cell Cij. The routine then proceeds to step S80 wherein it is determined whether a given period of time T5 has passed or not. If a YES answer is obtained, then the routine proceeds to step S82 wherein an output of the A/D converter 44 which represents the voltage across the in-module capacitor Cc is sampled. The period of time T5 is selected to be a length of time required for an input voltage to the A/D converter 44 to become stable and longer than a time constant of the RC circuit.

After the output of the A/D converter 44 is sampled in step S82, the routine proceeds to step S84 wherein the switching devices QCpj and QCnj are turned off. The routine proceeds to step S86 wherein it is determined whether the parameter j indicates “n” or not. This determination is made to determine whether voltages at all the battery cells Ci1 to Cin of the module Mi have been measured or not. If a NO answer is obtained, then the routine proceeds to step S88 wherein the parameter j is incremented by one (1). The routine then returns back to step S78. Alternatively, if a YES answer is obtained meaning that the measurement of voltages at all the battery cells CCi1 to Cin of the module Mi has been completed or after step S72, the routine terminates.

As apparent from the above discussion, the CPU 46 samples the output of the A/D converter 44 cyclically to detect the voltage at which the in-module capacitor Cc is charged, thereby detecting or acquiring the voltages at all the battery cells Ci1 to Cin of the module Mi. The structure of this embodiment results in a decrease in number of the RC circuits and the Zener diodes ZD.

The measurement of voltage at the battery cell Cij is achieved in a condition wherein the in-module capacitor Cc and the battery cell Cij are connected. This enables the voltage input to the A/D converter 44 to be converted into the digital form when it is stabilized. This is because when being disconnected from the battery cell Cij, the energy in the in-module capacitor Cc may be released to an external electric circuit joined to the in-module capacitor Cc, thus resulting in instability of the voltage input to the A/D converter 44.

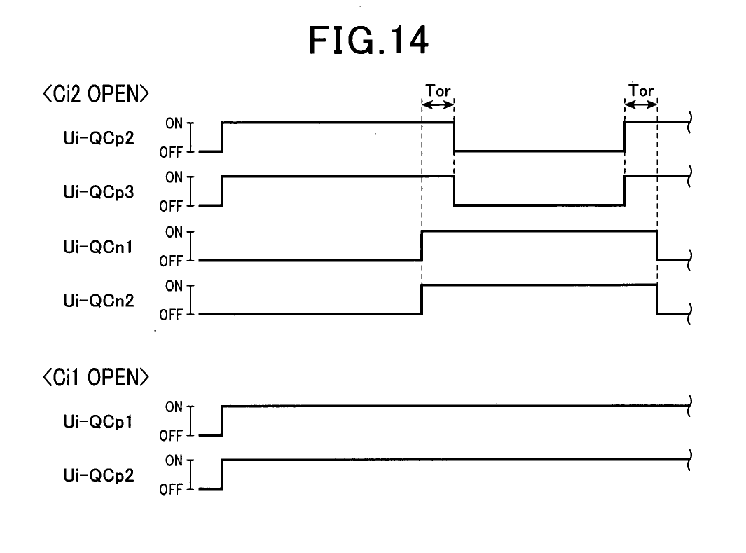

The charge/discharge system of the sixth embodiment will be described below with reference to FIG. 14 in which the microcomputer 40 functions as a fail-safe device using the in-module matrix converter MCC when an open fault has occurred at the battery cell Cij (i.e., any of the battery cells Ci1 to Cin).

When an open fault occurs, as illustrated in FIG. 14, at the battery cell Ci2 of the module Mi, the fail-safe device turns on the switching devices QCp2 and QCp3 of the in-module regulator unit Ui and then also turns on the switching devices QCn1 and QCp2 of the in-module regulator unit Ui thereby to connect the battery cells Ci1 and Ci3 through the in-module matrix converter MCC in order to utilize the electric energy in the high-voltage battery pack 10 to achieve a limp-home mode.

Specifically, the ECU 20 (not shown in FIG. 14) sets a first period of time for which the switching devices QCp2 and QCp3 of the in-module regulator unit Ui are turned on to be shifted from a second period of time for which the switching devices QCn1 and QCn2 of the in-module regulator unit Ui are turned on. In other words, the ECU 20 secures a period of time for which only the switching devices QCp2 and QCp3 are placed in the on-state and a period of time for which only the switching devices QCn1 and Qcn2 are placed in the on-state in order to alleviate a rise in temperature of the switching devices QCp2, QCp3, QCn1, and QCn2. The ECU 20 also secures an overlapping period of time Tor between the first period of time for which the switching devices QCp2 and QCp3 are placed on the on-state and the second period of time the switching devices QCn1 and QCn2 are placed in the on-state in order to keep the battery cells Ci1 and Ci3 connected electrically for a given period of time, in other words, establish the continuity of flow of charging or discharging current to or from the battery pack 10.

The above on-state switching operation is possible only for the battery cells Ci2 to Ci(n−1) other than the battery cells Ci1 and Cin located at ends of the array of the battery cells Ci1 to Cin in the module Mi. When the open fault has occurred at the battery cell Ci1, there is no electric path which is only permitted to be used in connecting the battery cell Ci1 to the negative pole of one of the battery cells Ci1 to Cin which is higher in potential than the battery cell Ci1 in the in-module regulator unit Ui. The fail-safe device, therefore, as illustrated in the lower portion of FIG. 14, keeps the switching devices QCp1 and QCp2 in the in-module regulator unit Ui turned on. In this instance, the fail-safe device may limit the output from the high-voltage battery 10 more than when the open fault occurs, for example, at the battery cell Ci2.

The open fault may be detected by monitoring whether the terminal voltage at the battery cell Cij has dropped extremely or not. For example, when a sampled value of the terminal voltage at the battery cell Cij has dropped greatly below a given threshold, the fail-safe device determines that the open fault is occurring at the battery cell Cij.

The above described charge/discharge systems may be modified as discussed below.

### Switching Device of Matrix Converter

The switching devices QMpi and QMni of the common module matrix converter MMC and the switching devices QCpj and QCnj of the in-module matric converter MCC are each implemented by a pair of n-channel MOS field-effect transistors connected in series, but may alternatively be composed of a pair of p-channel MOS field-effect transistors connected in series. The p-channel MOS field-effect transistors may be preferably arranged to have sources short-circuited to each other in order to use the sources in defining a reference for a potential at gates which work as open/close control terminals to turn on or off the p-channel MOS field-effect transistors. The p-channel MOS field-effect transistors may also be arranged to have drains short-circuited to each other. This results in a difficulty in sharing a single driver with the two p-channel MOS field-effect transistors, but avoids the flow-through-current which passes through the body diodes.

Each of the switching devices QMpi, QMni, QCpj, and QCnj may alternatively be implemented by a pair of insulated gate bipolar transistors (IGBTs) and diodes disposed in inverse-parallel connection to the IGBTs. The diodes serve to permit the current to flow bi-directionally in the matrix converter.

### In-Module Matrix Converter and Common Module Matrix Converter

The switching devices QMpi and QMni of the common module matrix converter MMC are designed to have a voltage resistance higher than that of the switching devices QCpj and QCnj of the in-module matric converter MCC, but the switching devices QMpi, QMni, QCpj, and QCnj may be identical in voltage resistance with each other. In this case, however, the rate at which the battery cells Ci1 to Cin which are not in use are charged with the regenerative energy may be increased in the third embodiment. This is because it is easy for the common module capacitor Cm to have a capacitance greater than that of the in-module capacitor Cc.

### Driver for Switching Device of Matrix Converter

The switching devices QMpi, QMni, QCpj, and QCnj are driven by the photo-couplers PMpi, PMni, PCpj, and PCnj which work as insulated signal transmitting devices to transmit a voltage signal from a primary side to a secondary side thereof which are electrically insulated from each other, but may alternatively be driven by transformers. The circuit size of the transformer may be prevented from being increased extremely compared to the above embodiments unless one of the on-duration and the off-duration of the switching devices QMpi, Qmni, QCpj, and QCnj for which the voltage induced at the secondary winding is used is longer than the other.

The insulated signal transmitting devices may be of a type not outputting the voltage signal.

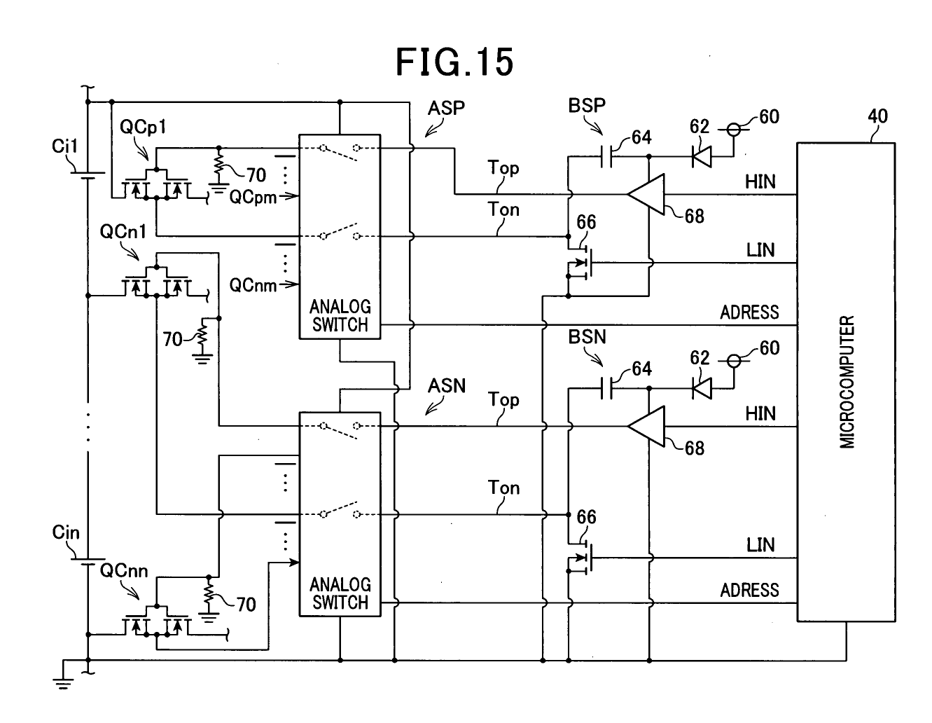

The common module matrix converter MMC and the in-module matric converter MCC may alternatively be constructed without use of the insulated signal transmitting devices. In the structure of FIG. 2, the microcomputer 40 and the module Mi are not electrically insulated from each other. The photo-couplers PCpj and PCnj are, therefore, not used for establish the insulation between the microcomputer 40 and the module Mi. FIG. 15 illustrates drivers for the switching devices QCpj and QCnj of the in-module matrix converter MCC. The drivers are not equipped with the insulated signal transmitting devices.

The charge/discharge system (i.e., the in-module regulator unit Ui) of FIG. 15 includes a bootstrap circuit BSP disposed on the positive pole side and a bootstrap circuit BSN disposed on the negative pole side. The bootstrap circuit BSP works. to produce voltage signals for turning on the switching devices QCp1 to QCpn. The bootstrap circuit BSN works to produce voltage signals for turning on the switching devices QCn1 to QCnn. Each of the bootstrap circuits BSP and BSN is equipped with a power supply 60. A series-connected combination of a diode 62, a floating power supply capacitor 64, and an n-channel MOS field-effect transistor (i.e., a charging switching device 66) is disposed between each of the power supply 60 and the negative pole of the module Mi. A driver circuit 68 is disposed between a joint of each of the floating power supply capacitor 64 and the cathode of a corresponding one of the diodes 62 and the negative pole of the module Mi. The driver circuits 68 are supplied with power from the floating power supply capacitors 64, respectively.

The microcomputer 40 outputs a charging input signal LIN to the gate of each of the charging switching devices 66 and a driving input signal HIN to each of the driver circuits 68. When the charging input signal LIN is changed to a logic high level H, the charging switching device 66 is turned on, so that the current flows from the power supply 60 to the charging switching device 66 through the diode 62 and the floating power supply capacitor 64. The floating power supply capacitor 64 is, then charged. When the charging input signal LIN is placed at the logic low level L, and the driving input signal HIN is placed at the logic high level H, the driver circuit 68 outputs the charging voltage for the floating power supply capacitor 64.

The low-side output terminals Ton of the bootstrap circuits BST and BSN are each connected between the floating power supply capacitor 64 and the charging switching device 66. The high-side output terminals Top of the bootstrap circuits BST and BSN are used as output terminals of the driver circuits 68, respectively. Therefore, when the charging input signal LIN is placed in the logic low level L, and the driving input signal HIN is placed in the logic high level H, it will cause the low-side output terminal Ton to be at a floating potential, the potential at the high-side output terminal Top to be higher than the potential at the low-side output terminal Ton by the voltage at the floating power supply capacitor 64.

The low-side output terminal Ton and the high-side output terminal Top of the bootstrap circuit BSP are connected to a positive side analog switch ASP. The positive side analog switch ASP works to selectively establish connections of the low-side output terminal Ton and the high-side output terminal Top of the bootstrap circuit BSP to the source and gate of any of the switching devices QCp1 to QCpn. The selection of one of the switching devices QCp1 to QCpn to which the bootstrap circuit BSP is to be connected electrically is made based on address data inputted from the microcomputer 40 to the analog switch ASP.

The low-side output terminal Ton and the high-side output terminal Top of the bootstrap circuit BSN are connected to a negative side analog switch ASN. The negative side analog switch ASN works to selectively establish connections of the low-side output terminal Ton and the high-side output terminal Top of the bootstrap circuit BSNP to the source and gate of any of the switching devices QCn1 to QCnn. The selection of one of the switching devices QCn1 to QCnn to which the bootstrap circuit BSN is to be connected electrically is made based on address data inputted from the microcomputer 40 to the analog switch ASN.

The analog switches ASP and ASN are supplied with electric power from the module Mi.

When it is required to connect, for example, the battery cells Ci1 and Ci2 to the in-module capacitor Cc, the microcomputer 40 outputs the charging input signals LIN of the logic low level L and the driving input signals HIN of the logic high level H to the switching devices 68 and the driver circuits 68, respectively, The microcomputer 40 also outputs address data to the analog switches ASP and ASN to select the switching devices QCp1 and QCn2 to which the bootstrap circuits BSP and BSN are to be connected. This causes the potential difference between the source and drain of each of the switching devices QCp1 and QCn2 to be developed as the voltage (i.e., the charging voltage) at which a corresponding one of the floating power supply capacitors 64 is charged.

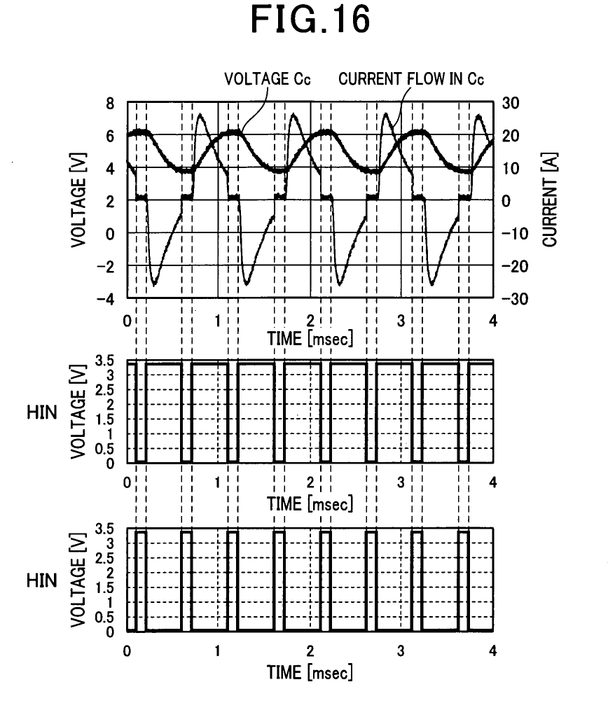

FIG. 16 demonstrates the charging voltage for the in-module capacitor Cc, the current charged in or discharged from the in-module capacitor Cc, the charging input signal LIN, and the driving input signal HIN.

Conductors connecting the analog switches ASP and ASN to the gates of the switching devices QCp1 to QCpn and QCn1 to QCnn are pulled down to the negative pole of the module Mi through the resistors 70, respectively, thereby keeping the gates of the switching devices QCp1 to QCpn and QCn1 to QCnn at a potential which brings them into the off-state (i.e., the potential at the negative pole of the module Mi in this embodiment) when it is required to turn off the switching devices QCp1 to QCpn and QCn1 to QCnn.

### Battery Cell Switch (Matrix Converter)

The charge/discharge system of the fourth embodiment, as illustrated in FIG. 11, is not equipped with the common module matrix converter MMC and the in-module matrix converters MCC, but may alternatively be engineered to have another structure. For instance, the charge/discharge system may include a single matrix converter which works to establish or block an electric connection of each of the battery cells C11 to Cmn of the battery pack 10 to a capacitor.

The charge/discharge system may be designed, as described later in detail, to permit the electric current to flow only from one or some of the modules M1 to Mm to the capacitor Cm and only from the capacitor Cm to the others of the modules M1 to Mm.

### The Number of Battery Cells to be Used in Charging or Discharging Capacitor

In the first and second embodiments, the number nc of ones of the battery cells Ci1 to Cin of the module Mi which are to be used in charging the in-module capacitor Cc is set greater than the number nd of ones of the battery cells Ci1 to Cin of the module Mi to which the electric energy is to be released from the in-module capacitor Cc. Similarly, the number Nc of ones of the modules M1 to Mm which are to be used in charging the common module Cm is set greater than the number Nd of ones of the modules M1 to Mm to which the electric energy is to be released from the in-module capacitor Cm. However, one of the battery cells Ci1 to Cin of the module Mi which is the highest or higher in terminal voltage than a given level may be discharged, while one of the battery cells Ci1 to Cin of the module Mi which is the lowest or lower in terminal voltage than the given level may be charged. The same is true for the regulation of variation in terminal voltage among the modules M1 to Mm.

### Setting of Potential

The potential at the negative pole of the battery pack 10 may be set to a potential at the body of the vehicle. In this case, the m^{th} module Mm may be used as a power supply for the ECU 20. This, however, accelerates the rate at which the energy in the m^{th} module Mm is consumed as compared with the other modules M1 to M(m−1), but the common module matrix MMC may be used to compensate for a drop in energy in the m^{th} module Mm with electric energy in the other modules M1 to M(m−1). As long as the switching devices QPp1 to QMp(m−1) are used only to charge the m^{th} module Mm, the switching devices QMp1 to QMp(m−1), and QMnm may be engineered to permit the current to flow only from the modules M1 to Mm−1 to the common module capacitor Cm. Similarly, the switching devices Qmn1 to QMn(m−1), and QMpm may be engineered to permit the current to flow only from the capacitor Cm to the m^{th} module Mm.

### Another Purpose of Use of Battery Cell Switch

The common module matrix converter MMC and the in-module matric converters MCC, as apparent from the above discussion, each work as a state-of-charge regulator or a battery assembly-to-battery assembly energy transmitter, but may alternatively be employed for another purpose. For example, when the temperature of the high-voltage battery pack 10 is lower than a required level, the in-module matric converter MCC serves to charge or discharge the battery cells C11 to Cmn cyclically to elevate the temperature of the battery pack 10. Usually, the greater the amount of current charged to or discharged from the battery cells C11 to Cmn, the greater the quantity of heat produced by the internal resistance of the battery cells Ci1 to Cmn, thus resulting in an increase in rate at which the temperature of the battery pack 10 rises. The charge/discharge system may, therefore, increase the number of ones of the battery cells C11 to Cmn which are used in charging the in-module capacitors Cc or decrease the number of ones of the battery cells C11 to Cmn to which the energy is released from the in-module capacitors Cc with a decrease in temperature of the battery pack 10. Of course, the common module matrix converter MMC may be used to charge or discharge the common module capacitor Cm for the same purpose.

### Changing of Number of Battery Cells

The number of the battery cells C11 to Cmn or the modules M1 to Mm may be changed as a function of a variation in terminal voltage or state of charge among the battery cells C11 to Cmn or the modules M1 to Mm to regulate the charged capacities of the battery cells C11 to Cmn, but it may be made, as described above, to regulate the temperature of the battery pack 10.

### Target Battery Cell to be Regulated in State of Charge

The charge/discharge system of the first and second embodiments may be engineered to regulate the state of charge in the module Mi in units of adjacent two of the battery cells Ci1 to Cin. Specifically, each adjacent two of the battery cells Ci1 to Cin is defined as a battery pair. The microcomputer 40 monitors a total terminal voltage, a total state of charge, or a total charge capacity at or of each of the batter pairs and uses one of some of the battery pairs in charging the capacitor Cc to minimize a variation in the total terminal voltage, the total state of charge, or the total charge capacity among the battery pairs.

### Sub-Battery Assembly

Every adjacent two of the sub-battery assemblies, as illustrated in FIG. 11, share one of the battery cells C11 to Cmn with each other, but may share two or more of the battery cells C11 to Cmn with each other.

### Determination of One of Battery Cell Having Maximum or Minimum Terminal Voltage, State of Charge, or Charged Capacity

In step S12 of FIG. 3, the charge/discharge system may select one of the battery cells Ci1 to Cin of the module Mi which is greater or smaller in terminal voltage, state of charge, or charged capacity than an average value in the module Mi as the battery cell Cih or Ci1. Alternatively adjacent some of the battery cells Ci1 to Cin which are greater in terminal voltage, state of charge, or charged capacity than the average value may be selected as being ones from which the electric energy is to be released to the in-module capacitor Cc. Similarly, in step S34 of FIG. 4, the charge/discharge system may select one of the modules M1 to Mm which is greater or smaller in terminal voltage, state of charge, or charged capacity than an average value in the battery pack 10 as the module Mh or M1. Alternatively, adjacent some of the modules M1 to Mm which are greater in terminal voltage, state of charge, or charged capacity than the average value may be selected as being ones from which the electric energy is to be released to the common module capacitor Cm.

Energy Shuttling between Battery Packs

The charge/discharge system of the third embodiment, as illustrated in FIG. 9, may alternatively be modified to transmit the electric energy from one of the first and second high-voltage battery packs 10a and 10b to the other when the other. For instance, when the voltage at at least one of the battery cells C11 to Cmn of the first high-voltage battery pack 10a has dropped below a lower limit, and thus, the second high-voltage battery pack 10b has started to be used, the charge/discharge system may transfer the electric energy from some of the battery cells C11 to Cmn to Cmn of the first high-voltage battery pack 10a which are kept in voltage above the lower limit to the second high-voltage battery pack 10b. In this case, the in-module capacitors Cc may be shared with the first and second high-voltage battery packs 10a and 10b.

Energy Storage Device Shared with Battery Packs

The charge/discharge system of the third embodiment, as illustrated in FIG. 9, may be designed to have the matrix converters of the fourth embodiment, as illustrated in FIG. 11, instead of the matrix converters MMC. A combination of the capacitors Cc1 to Ccm may be shared between the first and second high-voltage battery packs 10a and 10b. This modified structure may also be designed to perform the function, as discussed in the above section “ENERGY SHUTTLING BETWEEN BATTERY PACKS”.

The charge/discharge system of FIG. 9 may be engineered to have three or more battery packs. A combination of the capacitors Cc1 to Ccm may be shared between all the battery packs.

### Voltage Measurement Device

The regulator unit Ui, as illustrated in FIG. 2, may also be equipped with a differential amplifier disposed between the ends of the module Mi and the A/D converter 44, thereby permitting a voltage detectable range of the A/D converter 44 to be narrowed.

Instead of measurement of the voltage at the in-module capacitor Cc in the structure of the fifth embodiment, as illustrated in FIG. 12, the voltage at the common module capacitor Cm may be detected to determine the terminal voltages at the modules M1 to Mm. Additionally, an output voltage of the RC circuit of FIG. 12 may be converted by a differential amplifier and then inputted to the A/D converter 44. The differential amplifier, however, consumes the electric energy in the in-module capacitor Cc. It is, therefore, advisable that the measurement of the voltage at the in-module capacitor Cc be achieved in a condition where the connection of the in-module capacitor Cc and the battery cell Cij (i.e., one of the battery cells Ci1 to Cin which is to be determined in terminal voltage) is being kept by the matrix converter MCC. Alternatively, a voltage follower may be disposed between the RC circuit and the differential amplifier.

### How to Measure Voltage

The charge/discharge system of the fifth embodiment, as illustrated in FIG. 13, may be designed to measure the voltage at the in-module capacitor Cc in a condition where the connection of the battery cell Cij and the in-module capacitor Cc is opened by the matrix converter MCC.

Clamp Enable/Inhibit Device and Driver therefor

The charge/discharge system of FIG. 12 has the Zener diode ZD connected in parallel to the in-module capacitor Cc. The switching device Sn works as a clamp enable/inhibit device. The clamp enable/inhibit device may open the electric connection between the in-module capacitor Cc and the Zener diode ZD to clamp the voltage appearing at the in-module capacitor Cc. The microcomputer 40 may measure such a clamped voltage in step S82 of FIG. 13. Alternatively, the clamp enable/inhibit device may close the electric connection between the in-module capacitor Cc and the Zener diode ZD so as not to clamp the voltage appearing at the in-module capacitor Cc. The microcomputer 40 may measure such a undamped voltage in step S82 of FIG. 13. The photo-coupler Pn works as a driver for the clamp enable/inhibit device. The switching device Sn and the photo-coupler Pn may be replaced with other similar devices, as described above.

The charge/discharge system of FIG. 12 may also include two switching devices to open or close between the positive poles of the in-module capacitor Cc and the RC circuit (i.e., LPF) and between the negative poles of the in-module capacitor Cc and the RC circuit, respectively. The charge/discharge system may be designed to turn off the matrix converter MCC when the switching devices are turned on. This eliminates the need for the Zener diode ZD and permits a required voltage resistance of the A/D converter 44 to be decreased.

### Fail-Safe Device

When the battery cell Ci1 to Cin located at the ends of the module Mi has experienced the open fault in the six embodiment of FIG. 14, the fail-safe device works to fix ones of the switching devices QCp1 to QCpn to QCn1 to QCnn for use in bypassing the battery cell Ci1 to Cin, however, others of the switching devices QCp1 to QCpn and Qcn1 to QCnn may be used. For instance, when the open fault has occurred at the battery cell Ci1, the fail-safe device may keep the switching device QCp1 on at all times and turn on the switching devices QCp2 and QCp3 alternately in a cycle.

The fail-safe device, as described above, secures a period of time for which only the switching devices QCp2 and QCp3 are placed in the on-state and a period of time for which only the switching devices QCn1 and QCn2 are placed in the on-state in order to alleviate a undesirable rise in temperature of the in-module matrix converter MCC, but may take another measure. For instance, the battery cell Ci2 has undergone the open fault, the fail-safe device may keep the switching devices QCp2, QCp3, QCn1, and QCn2 on at all the time. This causes the amount of current flowing through each of the switching devices QCp2, QCp3, QCn1, and QCn2 to be decreased as compared with when the switching devices QCp2 and QCp3 or the switching devices QCn1 and QCn2 are turned on, thus decreasing the amount of heat produced in the in-module matrix converter MCC. In the case of use of the bootstrap circuits BSP and ESN, as illustrated in FIG. 15, the alternate turning on of a combination of the switching devices QCp2 and QCp3 and a combination of the switching devices QCn1 and QCn2, as illustrated in FIG. 14, is also useful for securing a period of time in which the floating power supply capacitors 64 are charged in addition to reduction in amount of heat in the in-module matrix converter MCC.

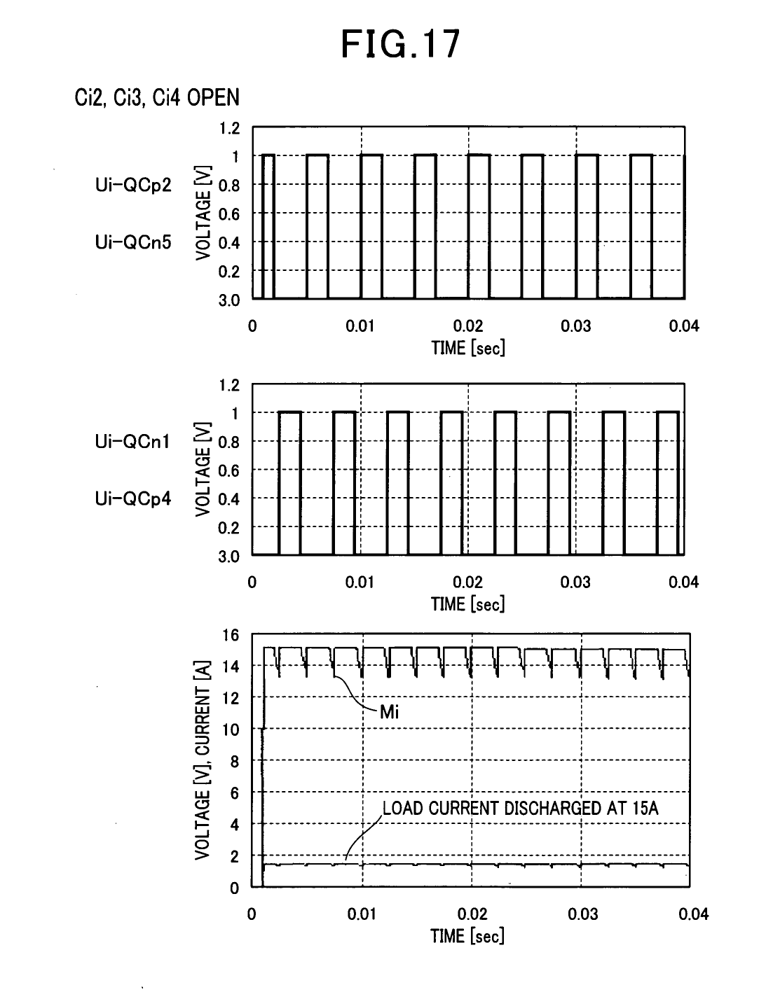

FIG. 17 illustrates an example of a fail-safe operation on the structure of FIG. 15 when the open fault has occurred in the battery cells Ci2, Ci3, and Ci4. The fail-safe device turns on a combination of the switching devices QCp2 and QCp5 and a combination of the switching devices QCn1 and QCn4 alternately in a cycle. In this time frame, the fail-safe device also schedules time intervals in which any of the switching devices QCp2, QCp5, Qcn1, and QCn4 is not turned on for charging the floating power supply capacitors 64. In the drawing, the terminal voltage at the module Mi drops, but reaches zero in an off-duration of any of the switching devices QCp2, QCp5, QCn1, and QCn4. This is due to a lag between switching of the driving input signal HIN to the logic level L and complete turning off of the switching devices QCp2, QCp5, QCn1, and QCn4.

Even in the case of use of the bootstrap circuits BSP and BSN, it is possible, like in FIG. 14, to secure an overlap between the period of time in which the switching devices QCp2 and QCp5 are turned on and the period of time in which the switching devices QCn1 and QCn4 are turned on. This is achieved, like the structure of FIG. 15, by using a pair of an analog switch ASP and a bootstrap circuit BSP and a pair of an analog switch ASN and a bootstrap circuit .BSN to make first pairs of an even-numbered one and an odd-numbered one of the battery cells Ci1 to Cin and second pairs of another even-numbered one and another odd-numbered one of the battery cells Ci1 to Cin and turning on or off the first pairs and the second pairs alternately.

The charge/discharge system of the sixth embodiment, as illustrated in FIG. 14, uses the in-module matrix converters MCC for the fail-safe operation, but may alternatively employ the common module matrix converter MMC. For example, when any of the battery cells Ci1 to Cin of the module Mi has failed in operation, the fail-safe device turns on the switching devices QMpi and QMni to secure an electric line bypassing the module Mi in the battery pack 10.

### Completion of Charging Operation

The charge/discharge system of each of the above embodiments makes a determination that each of the common module capacitor Cm and the in-module capacitors Cc has been charged completely after a lapse of a given period of time, but such a determination may be made based on the terminal voltage at the battery cell Cij or the module Mi.

### Setting of Capacitance of Energy Storage Device

If an electric connection of the module Mi to the in-module capacitor Cc may result in an excessive increase in electric current released from the module Mi to the in-module capacitor Cc, the number of the battery cells Ci1 to Cin to be connected to the in-module capacitor Cc may be decreased. Alternatively, the on/off operations of the switching devices QCp1 to QCnn may be controlled in a PWM (Pulse Width Modulation) control mode without keeping switching devices QCp1 to QCnn on for avoiding the excess of electric energy released from the module Mi. Further, the amount of current released from the module Mi may also be limited by controlling the potential at open/close control terminals (i.e., gates) of the switching devices QCp1 to QCnn so that the switching devices QCp1 to QCnn are turned on in a range in which the current released from the module Mi is lower than or equal to the current permitted to flow through the switching devices QCp1 to QCnn.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

The battery cells C11 to Cmn of the battery pack 10 may be different in structure, capacity, or characteristic from each other. For instance, the battery cell Cmn may be used to supply power to an accessory such as a clock mounted in a cabin of the vehicle and designed to have a fully charged capacity greater than those of the other battery cells C11 to Cm(n−1). In this case, the potential at the negative pole of the high-voltage battery 10 may be the potential at the body of the vehicle.

The battery pack 10 is not limited to use in supply electric power through the power converter to the electric motor for driving the vehicle, but may be employed in other applications.

When the voltage resistance of the A/D converters 44 is great, the Zener diode ZD may be omitted. When adverse effects of noise on the operation of the charge/discharge system may be ignored, the RC circuits (i.e., LPFs) may be omitted.

What is claimed is:

1. A charge/discharge system comprising:
an electric energy storage;
a battery pack in which a plurality of battery cells are disposed in series connection with each other;
a switch which works to selectively establish an electrical connection of a first cell group made up of one or a first number of adjacent ones of the battery cells with the electric energy storage in a first switching operation mode and an electrical connection of a second cell group made up of one or a second number of adjacent ones of the battery cells with the electric energy storage in a second switching operation mode; and
a charge/discharge controller which selectively places the switch in the first switching operation mode to establish a charging mode to charge electric energy from the first cell group to the electric energy storage and the second switching operation mode to establish a discharge mode to discharge electric energy from the electric energy storage to the second cell group.

2. A charge/discharge system as set forth in claim 1, wherein the first number is greater than the second number.

3. A charge/discharge system as set forth in claim 1, wherein the charge/discharge controller works to control an operation of the switch to change a difference between the first number and the second number.

4. A charge/discharge system as set forth in claim 1, wherein the charge/discharge controller transfers the electric energy from the first cell group to the electric energy storage in the first switching operation mode and then releases the electric energy from the electric energy storage to the second cell group in the second switching operation mode to regulate a state of charge in each of the battery cells.

5. A charge/discharge system as set forth in claim 4, wherein the switch includes a plurality of pairs of circuit paths each pair of which establishes an electric connection of terminals of one of the battery cells with terminals of the electric energy storage, and wherein the switch works to open or close each of the pairs circuit paths and permit an electric current to flow bi-directionally in each of pairs of the circuit paths.

6. A charge/discharge system as set forth in claim 5, wherein the charge/discharge controller selects a higher charged battery cell that is one of the battery cells which is greater in one of terminal voltage, state of charge, and charged capacity than other battery cells and a lower charged battery cell that is one of the battery cells which is smaller in one of terminal, voltage, state of charge, and charged capacity than other battery cells, and wherein the first cell group includes the higher charged battery cell or a combination of the higher charged battery cell and at least one of the battery cells connected adjacent the higher charged battery cell, and the second cell group includes the lower charged battery cell or a combination of the lower charged battery cell and at least one of the battery cells connected adjacent the lower charged battery cell.

7. A charge/discharge system as set forth in claim 4, wherein the switch is configured to change a difference between the first number of the battery cells to be connected to the electric energy storage in the charging mode and the second number of the battery cells to be connected to electric energy storage in the discharging mode, and the charge/discharge controller controls an operation of the switch to change the difference between the first number and the second number.

8. A charge/discharge system as set forth in claim 1, wherein the charge/discharge controller serves to measure a voltage, as developed across terminals of each of the battery cells to control an operation of the switch.

9. A charge/discharge system as set forth in claim 1, wherein the charge/discharge controller serves to measure a voltage, as developed across terminals of the electric energy storage to an operation of the switch.

10. A charge/discharge system as set forth in claim 1, further comprising a low-pass filter disposed between the electric energy storages and the charge/discharge controllers.

11. A charge/discharge system as set forth in claim 5, wherein one of the circuit paths of each of the pairs works as a first circuit path which connects between a joint between adjacent two of the battery cells and one of the terminals of the electric energy storage, and the other of the circuit paths works as a second circuit path which selectively establishes an electric connection between the joint and the other of the terminals of the electric energy storage.

12. A charge/discharge system as set forth in claim 11, wherein when a first battery cell that is one of the battery cells has failed in operation, the charge/discharge controller works as a fail-safe device to close the second circuit path joined to the first battery cell to establish the electric connection between the joint of the other of the terminals of the electric energy storage.

13. A charge/discharge system comprising:
a battery pack made up of a plurality of modules connected electrically to each other, each of the modules including a plurality of battery cells connected in series witch each other;
a common electric energy storage;
in-module electric energy storages each of which is disposed in one of the modules;
a common switch which works to selectively establish an electrical connection of a first module group made up of one or a first number of adjacent ones of the modules with the common electric energy storage in a first switching operation mode and an electrical connection of a second module group made up of one or a second number of adjacent ones of the modules with the common electric energy storage in a second switching operation mode;
in-module switches each of which is disposed in one of the modules, each of the in-module switches working to selectively establish an electrical connection of a first cell group made up of one or a first number of adjacent ones of the battery cells in a corresponding one of the modules with a corresponding one of the in-module electric energy storages in a third switching operation mode and an electrical connection of a second cell group made up of one or a second number of adjacent ones of the battery cells in a corresponding one of the modules with a corresponding one of the in-module electric energy storage in a fourth switching operation mode;
a common charge/discharge controller which selectively places the common switch in the first switching operation mode to establish a charging mode to charge electric energy from the first module group to the common electric energy storage and the second switching operation mode to establish a discharge mode to discharge electric energy from the common electric energy storage to the second module group; and
in-module charge/discharge controllers each of which is disposed in one of the modules, each of the in-module charge/discharge controllers selectively placing a corresponding one of the in-module switches in the third switching operation mode to establish an in-module charging mode to charge electric energy from the first cell group to a corresponding one of the in-module electric energy storages and the fourth switching operation mode to establish an in-module discharge mode to discharge electric energy from the one of the electric energy storages to the second cell group;

14. A charge/discharge system as set forth in claim 13, wherein the common charge/discharge controller selects a higher charged module that is one of the modules which is greater in one of terminal voltage, state of charge, and charged capacity and a lower charged module that is one of the modules which is smaller in one of terminal voltage, state of charge, and charged capacity, wherein the first module group includes the higher charged module or a combination of the higher charged module and at least one of the modules connected adjacent the higher charged module, and the second module group includes the lower charged module or a combination of the lower charged module and at least one of the modules connected adjacent the lower charged module, wherein each of the in-module charge/discharge controllers selects a higher charged battery cell that is one of the battery cells which is greater in one of terminal voltage, state of charge, and charged capacity in a corresponding one of the modules and a lower charged battery cell that is one of the battery cells which is smaller in one of terminal voltage, state of charge, and charged capacity in the one of the modules, and wherein the first cell group includes the higher charged battery cell or a combination of the higher charged battery cell and at least one of the battery cells connected adjacent the higher charged battery cell, and the second cell group includes the lower charged battery cell or a combination of the lower charged battery cell and at least one of the battery cells connected adjacent the lower charged battery cell.

15. A charge/discharge system as set forth in claim 13, further comprising a plurality of pairs of circuit paths each pair of which establishes an electric connection of terminals of one of the modules with terminals of the common electric energy storage, and wherein each of the in-module switches works to open or close each of the pairs circuit paths in a corresponding one of the modules and permit an electric current to flow bi-directionally in each of pairs of the circuit paths.

16. A charge/discharge system as set forth in claim 13, wherein the common switch is configured to change a difference between the first number of the modules to be connected to the common electric energy storage in the charging mode and the second number of the modules to be connected to common electric energy storage in the discharging mode, and the common charge/discharge controller controls an operation of the common switch to change the difference between the first number and the second number.

17. A charge/discharge system as set forth in claim 13, wherein a combination of the battery cells of each of the modules and at least one of the battery cells of an immediately closest neighbor one of the modules constitutes a sub-battery assembly, and wherein each of the sub-battery assemblies is connectable with one of the in-module electric energy storages.

18. A charge/discharge system as set forth in claim 13, wherein the battery cells of the battery pack are broken down into a first sub-battery pack and a second sub-battery pack which are connected in parallel to each other, wherein the common switch is provided for each of the first and second sub-battery packs, and the common electric energy storage is shared by the first and second sub-battery packs.

19. A charge/discharge system as set forth in claim 18, wherein the common charge/discharge controller works to control operations of the switches for the first and second sub-battery packs to transfer electric energy from one of the first and second sub-battery packs to the other through the common electric energy storage.

20. A charge/discharge system as set forth in claim 13, wherein each of the in-module charge/discharge controllers serves to measure a voltage, as developed across terminals of each of the battery cells to control an operation of a corresponding one of the in-module switches.

21. A charge/discharge system as set forth in claim 13, wherein each of the in-module charge/discharge controllers serves to measure a voltage, as developed across terminals of a corresponding one of the in-module electric energy storages to control an operation of a corresponding one of the in-module switches.

22. A charge/discharge system as set forth in claim 13, wherein the common charge/discharge controller serves to measure a voltage, as developed across terminals of the common electric energy storage to an operation of the common switch.

23. A charge/discharge system as set forth in claim 13, further comprising a low-pass filter disposed between each of the in-module electric energy storages and a corresponding one of the in-module charge/discharge controllers.

24. A charge/discharge system as set forth in claim 21, further comprising Zener diodes connected to the in-module charge/discharge controllers in parallel to the in-module electric energy storages and switches which work to selectively open or close connections between the in-module electric energy storages and the Zener diodes.

25. A charge/discharge system as set forth in claim 21, wherein each of the in-module charge/discharge controllers measures the voltage, as developed across terminals of the one of the in-module electric energy storages while the one of the in-module electric storages are in connection with one of the battery cells.
